(19) United States
(12) Patent Application Publication
(10) Pub. No.: US 2024/0330090 A1
(43) Pub. Date: Oct. 3, 2024

(54) CLASSIFICATION OF INCIDENT AND ALERT DATA BASED ON PREDICTION MODELS GENERATED USING TRANSFORMED USER GENERATED CONTENT DATA

(71) Applicants: ATLASSIAN PTY LTD., Sydney (AU); ATLASSIAN (US) LLC, San Francisco, CA (US)

(72) Inventors: Atri MANDAL, Bangalore (IN); Prabu PALANISAMY, Bengaluru (IN)

(21) Appl. No.: 18/190,532

(22) Filed: Mar. 27, 2023

(51) Int. Cl. G06F 11/07; G06F 40/205; G06F 40/284; G06F 40/30

(52) U.S. Cl. CPC G06F 11/0769; G06F 40/205; G06F 40/284; G06F 40/30

(57) ABSTRACT

Apparatus, methods, and computer program products for categorizing a real-time monitoring service alert is provided. An example apparatus may include program code configured to cause the apparatus to retrieve the real-time monitoring service alert, the real-time monitoring service alert including a text string containing user generated content (UGC) text. In addition, the example apparatus may be configured to programmatically parse the text string of the real-time monitoring service alert to segregate the real-time monitoring service alert into an alert message problem component and an alert auxiliary details component. Further, the apparatus may be configured to determine, based on the alert message problem component, the alert auxiliary details component, and using an alert message machine learning model trained based on UGC transformed alert data, an alert message category of the real-time monitoring service alert.

### TECHNOLOGICAL FIELD

Embodiments of the present disclosure relate generally to generating incident and alert prediction models on an enterprise software platform, and more specifically, to performing modifications to the incident and alert training data to protect user generated content (UGC) when generating incident and alert prediction models.

### BACKGROUND

Applicant has identified many deficiencies and problems associated with existing methods, apparatuses, and systems for training machine learning models to predict alerts and address possible incidents associated with an enterprise software platform. Through applied effort, ingenuity, and innovation, these identified deficiencies and problems have been solved by developing solutions that are embodied in accordance with the embodiments of the present disclosure, many examples of which are described in detail herein. Various example embodiments address technical problems associated with utilizing alert and incident data, including user generated content and personally identifiable information (collectively referred to as “UGC”) to train machine learning models developed to classify and predict alerts, as well as address possible incidents associated with an enterprise software platform.

### BRIEF SUMMARY

In general, embodiments of the present invention provide methods, apparatuses, computer program products, and/or the like that are configured to classify a real-time monitoring service alert based on an alert message machine learning model generated using UGC transformed alert data.

In accordance with some embodiments of the present disclosure, an example apparatus for categorizing a real-time monitoring service alert is provided. In some embodiments, the apparatus may comprise at least one processor and at least one memory including program code, the at least one memory and the program code configured to, with the at least one processor, cause the apparatus to at least: retrieve the real-time monitoring service alert, the real-time monitoring service alert comprising a text string, including user generated content (UGC) text. In addition, the apparatus may be configured to programmatically parse the text string of the real-time monitoring service alert to segregate the real-time monitoring service alert into an alert message problem component and an alert auxiliary details component. Further, the apparatus may be configured to determine, based on the alert message problem component, the alert auxiliary details component, and using an alert message machine learning model trained based on UGC transformed alert data, an alert message category of the real-time monitoring service alert.

In some embodiments, the UGC transformed alert data may comprise an alert message problem embedding, wherein the alert message problem embedding is generated by applying feature extraction to the alert message problem component of the real-time monitoring service alert, and an alert message description embedding, wherein the alert message description embedding is generated by applying feature extraction to the alert auxiliary details component.

In some embodiments, generating an alert message problem embedding may comprise utilizing a word embedding technique on the alert message problem component.

In some embodiments, generating an alert message description embedding may comprise utilizing a sentence embedding technique on the alert auxiliary details component.

In some embodiments, the alert message machine learning model may be a machine learning classifier utilizing at least one of a support vector machine type classifier and a neural network type classifier.

In some embodiments, the alert message machine learning model may be updated based on feedback from one or more users.

In some embodiments, segregating the real-time monitoring service alert may comprise utilizing a semantic parser on the text string of the real-time monitoring service alert to segregate the alert message problem component from the alert auxiliary details component.

In some embodiments, the semantic parser may comprise at least one of a slot grammar parser and a bidirectional long-short term memory (Bi-LSTM) based conditional random field.

In some embodiments, segregating the real-time monitoring service alert may further comprise identifying one or more UGC data components of the text string of the real-time monitoring service alert corresponding to the UGC text and replacing each of the one or more UGC data components with one or more generic data tokens based at least in part on a UGC type of the UGC data component.

In some embodiments, generating an alert message problem embedding may further comprise performing one or more data mutation processes on the alert message problem component.

An example method for categorizing a real-time monitoring service alert is further provided. In some embodiments, the method may comprise retrieving the real-time monitoring service alert, wherein the real-time monitoring service alert comprises a text string, including user generated content (UGC) text. In addition, the method may further comprise programmatically parsing the text string of the real-time monitoring service alert to segregate the real-time monitoring service alert into an alert message problem component and an alert auxiliary details component. Further, the method may comprise determining, based on the alert message problem component, the alert auxiliary details component, and using an alert message machine learning model trained based on UGC transformed alert data, an alert message category of the real-time monitoring service alert.

In some embodiments, the UGC transformed alert data may comprise an alert message problem embedding, wherein the alert message problem embedding is generated by applying feature extraction to the alert message problem component of the real-time monitoring service alert. In some embodiments, the UGC transformed alert data may further comprise an alert message description embedding, wherein the alert message description embedding is generated by applying feature extraction to the alert auxiliary details component.

In some embodiments, generating an alert message problem embedding may comprise utilizing a word embedding technique on the alert message problem component.

In some embodiments, generating an alert message description embedding may comprise utilizing a sentence embedding technique on the alert auxiliary details component.

In some embodiments, the alert message machine learning model may be a machine learning classifier utilizing at least one of a support vector machine type classifier and a neural network type classifier.

In some embodiments, the alert message machine learning model may be updated based on feedback from one or more users.

In some embodiments, segregating the real-time monitoring service alert may comprise utilizing a semantic parser on the text string of the real-time monitoring service alert to segregate the alert message problem component from the alert auxiliary details component.

In some embodiments, the semantic parser may comprise at least one of a slot grammar parser and a bidirectional long-short term memory (Bi-LSTM) based conditional random field.

In some embodiments, segregating the real-time monitoring service alert may further comprise identifying one or more UGC data components of the text string of the real-time monitoring service alert corresponding to the UGC text and replacing each of the one or more UGC data components with one or more generic data tokens based at least in part on a UGC type of the UGC data component.

An example computer program product for categorizing a real-time monitoring service alert is further provided. In some embodiments, the computer program product may comprise at least one non-transitory computer-readable storage medium having computer-readable program code portions stored therein, the computer-readable program code portion configured to retrieve the real-time monitoring service alert, wherein the real-time monitoring service alert comprises a text string, including user generated content (UGC) text. Further, in some embodiments, the executable portion of the computer program product may be configured to programmatically parse the text string of the real-time monitoring service alert to segregate the real-time monitoring service alert into an alert message problem component and an alert auxiliary details component. In addition, in some embodiments, the executable portion of the computer program product may be configured to determine, based on the alert message problem component, the alert auxiliary details component, and using an alert message machine learning model trained based on UGC transformed alert data, an alert message category of the real-time monitoring service alert.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of an example enterprise software platform system architecture within which at least some embodiments of the present invention may operate.

FIG. 2 depicts a block diagram of generic computing components of an example alert monitoring and prediction service structured in accordance with an example embodiment of the present disclosure.

FIG. 3 depicts a block diagram of operating modules of an example alert monitoring and prediction service in accordance with an example embodiment of the present disclosure.

FIG. 4 depicts a block diagram of an example alert data transformation module in accordance with an example embodiment of the present disclosure.

FIG. 5 depicts a block diagram of an example alert message machine learning model generation module in accordance with an example embodiment of the present disclosure.

FIG. 6 depicts a block diagram of an example alert prediction module in accordance with an example embodiment of the present disclosure.

FIG. 7 depicts a flowchart diagram of an example process for generating UGC transformed alert data from a monitoring service alert corpus in accordance with an example embodiment of the present disclosure.

FIG. 8 depicts a flowchart diagram of an example process for protecting user generated content when generating UGC transformed alert data in accordance with an example embodiment of the present disclosure.

FIG. 9 depicts a flowchart diagram of an example process for classifying a monitoring service alert in accordance with an example embodiment of the present disclosure.

FIG. 10 provides operational examples of monitoring service alerts in accordance with an example embodiment of the present disclosure.

FIG. 11 illustrates a signal diagram of an example process for training an alert message machine learning model in accordance with an example embodiment of the present disclosure.

FIG. 12 illustrates a signal diagram of an example process for classifying a monitoring service alert in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

The complexity of enterprise software platforms has matured to a degree that there are now more potential failure points than ever. For example, many enterprise software platforms comprise one or more types of software applications, for example, monolithic software applications and/or service-oriented software applications. A given service-oriented platform alone could support hundreds of software applications and hundreds of thousands of features. Those applications and features could be supported by thousands of services and microservices that exist in vast and ever-changing interdependent layers. Adding to this complexity is the fact that at any given time, a great number of software development teams may be constantly, yet unexpectedly, releasing code updates that change various software services, launch new software services, change existing features of existing software applications, add new software applications, add new features to existing software applications, and/or the like. Still further complexity is added by the fact that a vast number of hardware and software components, each with their own operational conditions, security settings, and the like may be broken, breached, or otherwise compromised.

The impact of an incident on an enterprise software platform can be devastating. Some estimates suggest that major incidents can cost an organization $300,000 per hour that an enterprise software platform is down. To aid in the discovery of alerts and incidents, enterprise software platforms may utilize an alert monitoring and prediction service tool. An alert monitoring and prediction service tool is a software service that is configured to monitor a complex platform and detect alerts, cautions, problems, errors, issues, or incidents. Such example alert monitoring service tools may include Opsgenie® by Atlassian® and/or Jira Service Management® by Atlassian®. An alert monitoring and prediction service tool may be used to categorize incidents and alerts, correlate sets of alerts, predict incidents, determine incident similarity, and locate any potential fault, among other things.

An alert may comprise information, text, and/or other media used to describe the operating functionality and/or status of an enterprise software platform or a constituent service or microservice. Such operating functionality may include indicators regarding the enterprise software platform's performance (e.g., whether the complex platform and its functions are running at peak speed or slower than peak speed, if certain functions or capabilities are not running at peak performance or not running at all, etc.). Further, operating functionality may include security threats (e.g., unauthorized access, data breaches, etc.), compliance issues (e.g., violation of data privacy), system failures (e.g., application crash, server down, network connection lost, etc.) Alerts may further include user generated content (UGC), for example products, team names, server names, and other entity names; personal identifiable data, such as names, phone numbers, email addresses, addresses, and so on; locations, dates, times, URLs, or other data input by a user. Due to federal, state, and international regulations relating to UGC, significant restrictions apply to accessing, processing, and utilizing UGC. For example, data including certain types of UGC may not be used to train machine learning models utilized by alert monitoring and prediction service tools. The restrictions on the use of UGC in training machine learning models makes it extremely difficult to train a reliable machine learning model to perform tasks such as alert correlation, incident prediction, investigation, root cause analysis, and other prediction/analysis tasks related to alerts and incidents.

One interested in complying with UGC related regulations may attempt to train machine learning models to predict and classify alerts and incidents by relying only on usage data. Usage data may not contain UGC data, meaning machine learning models may be trained without user generated content. However, utilizing only usage data (without the UGC data) only enables an alert monitoring and prediction service tool to train naïve models. These naïve models will not have the desired accuracy when predicting and classifying incidents and alerts.

Truly predictive alert and incident machine learning models may be heavily dependent on UGC data. As a result, various embodiments of the present invention involve transforming a training corpus of alert and incident data containing UGC to obscure and anonymize the UGC in compliance with relevant privacy regulations while ensuring that such transformation does not limit the predictive effectiveness of the trained machine learning model.

To train accurate and reliable machine learning models to provide classification and predictions related to alerts and incidents on an enterprise software platform and comply with regulations in regard to UGC, non-linear transformations on the UGC data may be performed. Non-linear transformations make it impossible to infer the original data from the transformations, such that the privacy of the UGC data is maintained. The machine learning model may be subsequently trained on the transformed input data generating a machine learning model with the desired accuracy without utilizing the protected UGC data. Performing similar non-linear transformations on received monitoring service alerts during operation and utilizing the trained machine learning model, a monitoring service alert may be classified such that an alert monitoring and prediction service may categorize incidents and alerts, correlate sets of alerts, predict incidents, determine incident similarity, and/or locate any potential faults, among other things. In addition, during operation, a user may provide feedback regarding monitoring service alert classifications, causing updates to the training data and machine learning model generated by the alert message machine learning model generation module.

As a result of the herein described example embodiments and in some examples, the effectiveness of classifications and predictions based on incident and alert data received from an enterprise software platform may be greatly improved. In addition, non-linear transformations performed on the user-generated content allow the important aspects of the user-generated content to be utilized in compliance with regulations.

### Definitions

The term “enterprise software platform” refers to a software platform comprising one or more types of software applications (e.g., monolithic software applications and/or service-oriented software applications), which are described in more detail herein. An enterprise software network includes client devices, network circuitry, one or more alert monitoring and prediction services, and other services and applications interacting within the enterprise software platform.

The term “monolithic software application” refers to a single-tiered architecture in which the front-end and back-end systems are combined into a single platform. Monolithic software platforms are self-contained in that they can perform each operation needed to complete their intended purpose or function.

A “service-oriented software application” is characterized by large networks of interdependent services and microservices that support a myriad of software features and applications. Indeed, some large service-oriented software applications may be comprised of topologies of 1,500 or more interdependent services and microservices. Such service-oriented software applications may be nimble, highly configurable, and enable robust collaboration and communication between users at individual levels, team levels, and enterprise levels.

A service-oriented software application is configured to support hundreds of software applications and hundreds of thousands of features. Those applications and features could be supported by thousands of services and microservices that exist in vast and ever-changing interdependent layers. In a service-oriented software application, at any given time, a great number of software development teams may be constantly, yet unexpectedly, releasing code updates that change various software services, launch new software services, change existing features of existing software applications, add new software applications, add new features to existing software applications, and/or the like.

The term “alert monitoring and prediction service” refers to any software platform and associated hardware configured to monitor the operational state of one or more software applications, services, microservices, features, and/or other similar mechanisms within an enterprise software network. An alert monitoring and prediction service tool comprises a software service that is configured to detect alerts, warnings, problems, errors, issues, and/or incidents. For example, an alert monitoring and prediction service tool may comprise a software product such as Opsgenie® by Atlassian® and/or Jira Service Management® by Atlassian®. An alert monitoring and prediction service tool is used to categorize incidents and alerts, correlate sets of alerts, predict incidents, determine incident similarity, and/or locate any potential faults, among other things. An alert monitoring and prediction service further comprises an alert message machine learning model generation module, an alert prediction module, and an alert data transformation module.

The term “alert message machine learning model generation module” refers to any software module and associated hardware configured to generate a machine learning model from a monitoring service alert corpus. The alert message machine learning model generation module comprises and/or utilizes an alert data/transformation module to condition the monitoring service alerts stored in the monitoring service alert corpus for training.

The term “alert prediction module” refers to any software module and associated hardware configured to make a prediction, execute an action, and/or initiate a similar response based on the reception of a monitoring service alert. The alert prediction module further comprises and/or utilizes an alert data/transformation module to condition the monitoring service alerts received from an alert generation service.

The term “alert data transformation module” refers to any software module and associated hardware configured to receive a monitoring service alert and generate UGC transformed alert data based on the received monitoring service alert. An alert data transformation module modifies, updates, and/or removes user generated content (UGC) and personal privacy information (PPI) from the monitoring service alert, in preparation for machine learning model training, data classification, or other similar tasks. The alert data transformation module further parses the monitoring service alert message into alert message problem components or tokens and alert message auxiliary details components. The problem components or tokens and the description components or tokens are used to generate separately an alert message problem embedding and an alert message description embedding for use in generating a machine learning model and/or classifying a monitoring service alert.

The term “alert generation service” refers to any software applications, services, microservices, features, hardware devices, firmware, and/or other similar mechanisms within an enterprise software platform configured to generate and/or transmit incidents and alerts in the form of a monitoring service alert. The alert generation service generates incidents and alerts indicating the status of one or more components in an enterprise software platform. The alert generation service receives an alert or incident or alert from a triggering event and formats the available metadata into a monitoring service alert. The monitoring service alert may then be transmitted to the alert monitoring and prediction service and other components within the enterprise software platform.

The term “monitoring service alert” refers to any data construct and/or data object generated by an alert monitoring and prediction service indicating the status and/or operating functionality of a component, module, and/or device within the enterprise software platform. Such operating functionality may include indicators regarding the performance of a component (e.g., whether the component and its functions are running at peak speed or slower than peak speed, if certain functions or capabilities are not running at peak performance or not running at all, etc.). Further, operating functionality may include security threats (e.g., unauthorized access, data breaches, etc.), compliance issues (e.g., violation of data privacy), system failures (e.g., application crash, server down, network connection lost, etc.). Monitoring service alerts include alert attributes as defined herein. A monitoring service alert may be transmitted to specific interconnected components on the enterprise software network. Alternatively, or additionally, a monitoring service alert may be broadcast to the plurality of interconnected components. In some embodiments, one or more monitoring service alerts may be stored in a monitoring service alert corpus for use in training an alert message machine learning model.

The term “alert attributes” refers to any text, identifiers, metadata, or other alert related characteristics or features that are transmitted as part of a monitoring service alert. Example alert attributes include an alert identifier or title, a priority, a message field, notification parameters, entity or entities associated with the monitoring service alert, actions to be performed, time of the alert, description, and other properties related to the monitoring service alert. Each alert attribute comprises a label and a value having a certain data type. Some alert attributes comprise a value having UGC, for example, the message field.

The term “real-time monitoring service alert” refers to any monitoring service alert related to a presently occurring or recently occurring status and/or operating functionality of a component, module, and/or device within the enterprise software platform.

The term “UGC transformed alert data” refers to data that embodies monitoring service alerts, or some portion thereof, wherein constituent UGC data has been identified, modified, and replaced with placeholder data (e.g., a generic data token) that is not indicative of the original UGC data. UGC transformed alert data is structured, configured, and formatted for use in training a machine learning model. Modifications to the monitoring service alert may further include but are not limited to parsing one or more portions of the monitoring service alert into portions (e.g., tokens) and determining the type and/or purpose of the delimited text, for example, identifying each portion as an alert message problem component or an alert message auxiliary details component. Modifications may further include mutating or transforming portions of the monitoring service alert, for example, using one or more data mutation processes. In addition, modifications may further include a data mutation process, for example, generating word embeddings based on the text portions of the UGC transformed alert data.

The term “monitoring service alert corpus” refers to any repository, store, compilation, or other similar collection of monitoring service alerts. A monitoring service alert corpus is utilized to train an alert message machine learning model. In addition, the monitoring service alerts within a monitoring service alert corpus are utilized to compile an entity map, mapping entity names to a list of indexes.

The term “text string” refers to a data construct and/or data object comprising a sequence of one or more characters. A number of alert attributes comprise labels and/or values represented as text strings, including but not limited to the alert identifier, the priority, the message field, the notification parameters, the associated entities, the actions to be performed, the time of the alert, and the description.

The term “user generated content” or “UGC” refers to any data construct, including text strings, files, messages, videos, audio files, and the like, that are generated by a user and appended to or otherwise associated with monitoring service alerts. UGC may be entered by a user and included in a monitoring service alert, for example, in the description alert attribute. The UGC transformed alert data removes portions of the UGC data and/or replaces portions of the UGC data with generic tags while still preserving the maximum amount of relevant information such that useful insights from the UGC data may be preserved.

The term “alert message problem component” refers to a portion or portions of the monitoring service alert, indicating the problem, symptom, issue, operational condition, or other triggering event indicated by the monitoring service alert. The alert message problem component is determined using a semantic parser as described herein. A semantic parser, given a text string or sequence of tokens, selects a sequence of words or tokens which indicate the type of the sequence. The sequence of words may be stored in a string, list, or other data object as the alert message problem component. The alert message problem component is modified using non-linear transformations generating an alert message description embedding.

The term “alert message auxiliary details component” refers to a portion or portions of the monitoring service alert, providing details in support of the problem, symptom, issue, operational condition, or other event triggering the transmission of the monitoring service alert. The alert message auxiliary details component is modified using non-linear transformations separately from the alert message problem component to generate an alert message description embedding. For example, an embedding representing the alert message auxiliary details component may be generated using sentence embedding techniques. Utilizing sentence embedding techniques to generate an alert message description embedding representing the alert auxiliary details preserves auxiliary details of the monitoring service alert when generating the alert message machine learning model.

The term “alert message problem embedding” refers to any data construct or data object resulting from a transformation to an alert message problem component, formatting the alert message problem component for entry into a machine learning model training module and/or for classification by a machine learning model. The transformation performed on the alert message problem component to produce an alert message problem embedding comprises a non-linear transformation, such that, the alert message problem component may not be deduced from the alert message problem embedding. A non-linear transformation prevents determination of protected content in the monitoring system alert, particularly user generated content. The alert message problem embedding is determined in part due to feature extraction, as described herein.

The term “alert message description embedding” refers to any data construct or data object resulting from a transformation applied to an alert message auxiliary details component, formatting the alert message auxiliary details component for entry into a machine learning model training module or an alert classifier. An alert message description embedding preserves sufficient auxiliary details enabling improved accuracy in the machine learning model and classification based on monitoring service alerts. In some embodiments, the alert message description embedding may be generated in part from a sentence embedding. A sentence embedding may embed full sentences as contained in the alert message auxiliary details component into a vector space. A sentence embedding may result in preservation of the auxiliary details when generating a machine learning model. A sentence embedding may comprise a universal sentence embedding, such as InferSent.

The term “feature extraction” refers to any algorithm configured to generate a non-linear transformation of word or sentence data into an embedding format suitable for entry into a machine learning model training module or classifier. Feature extraction may include generating word embeddings on each word in a sample text string (e.g., monitoring service alert title or description), using a word embedding technique, such as word2vec. A word embedding technique, produces a vector space based on the words contained in the monitoring service alert corpus and/or received monitoring service alerts during operation. Then, each word in the sample text string is mapped into the word space based on the word. The words in the sample text string may be combined into bigrams and trigrams. For example, word pairs (bigrams) or sets of three words (trigrams) making up a phrase or term may be concatenated with an underscore and a word embedding may be generated based on the concatenated phrase or term. Generating embeddings based on phrases or terms preserves important information contained in the sample text string, which is later utilized in the classification of a received monitoring service alert during operation. In some embodiments, the generated embeddings may be stored with an inverse document frequency score (IDF) as further described herein.

The term “alert message machine learning model” refers to a data construct that is configured to describe parameters, hyper-parameters, and/or defined operations of a machine learning model that is configured to process a title, description, and other text string data associated with a monitoring service alert in order to classify the monitoring service alert according to a pre-defined category, as further described herein. The alert message machine learning model may comprise an artificial neural network such as a multilayer perceptron neural network, a long short-term memory (LSTM) neural network, a convolutional neural network, or similar network. The parameters and/or hyper-parameters are determined based on training performed on the monitoring service alert corpus. Once trained, the alert message machine learning model is stored in a memory such as an alert message machine learning model storage for operational use in the classification of received monitoring service alerts.

The term “alert message delimiters” refers to any character, sequence of characters, or set of characters that may be contained in a text string. Alert message delimiters are used to break down or tokenize a received text string associated with a monitoring service alert into a set of portions or tokens. Delimiting the text string based on alert message delimiters creates a set or sequence of unique tokens, sometimes referred to as a bag of words. White space characters such as spaces, tabs, newlines, and carriage returns may be included in the alert message delimiters. Other specific delimiters include but are not limited to commas, semicolons, colons, periods, equals signs, and other characters.

The term “semantic parser” refers to any algorithm comprising software and/or hardware configured to receive a sequence of words and/or tokens and produce a logical representation of the sequence of words using a semantic parsing method. Semantic parsing methods may include but are not limited to an English slot grammar (ESG) parser, bidirectional long-short term memory (BI-LSTM) based conditional random field (CRF) parsers, or other similar parsers. The semantic parser is utilized to determine the tokens related to the problem, symptom, issue, operational condition, or other triggering event indicated by the monitoring service alert title and description and compile an alert message problem component containing those words. In addition, the semantic parser generates an alert message auxiliary details component based on the determined tokens.

The term “English slot grammar (ESG) parser” refers to a semantic parsing method for performing a linguistic analysis on a text string and determining the text content of a sample text string. An ESG parser comprises a pretrained model configured to generate a plurality of parse trees corresponding to a text string using deep parsing. The ESG parser then scores the resulting parse trees and selects the most likely parse tree based on the scoring analysis. The parse tree may be generated by tokenizing the input text string, performing a lexical analysis, and further performing a syntactic analysis. The parse tree generates a graphical structure which contains the core semantic meaning of the sentence. The problem, symptom, issue, operational condition, or other triggering event indicated by the monitoring service alert title and description is then determined using a template analysis of the parse tree.

The term “bidirectional long-short term memory (Bi-LSTM) based conditional random field (CRF) parser” refers to a semantic parsing method that labels words or sequences of words using machine learning techniques. A conditional random field generates labels for words received in a text string associated with a monitoring service alert. A conditional random field analysis utilizes statistics and probabilities to determine the most likely label for a given word or sequence of words. The Bi-LSTM based CRF parser may be trained on English sentences in the public domain using beginning, inside, and outside (BIO) encoding. Pre-built models may be utilized to support a Bi-LSTM based CRF parser. The problem, symptom, issue, operational condition, or other triggering event indicated by the monitoring service alert title and description may be determined based on the labeling indicated by the Bi-LSTM based CRF parser.

The term “UGC data components” refers to any data construct or data object comprising characters, sequences of characters, words, text strings, or other character representations that were generated or selected by a user.

The term “generic data tokens” refers to any label, tag, identifier, marker, symbol, or other text representation describing or classifying a token or sequence of tokens generically. For example, a text string may include tokens referring to specific objects, such as URLs, times, locations, regions, server names, email-ids, and other specific references. A generic data token is used to replace a specific reference in a UGC data component with a generic tag. As an example, a text string may include a time, for example, 5 seconds. A generic data token selected to replace the specific time “5 seconds” may be “<time>.” Other generic data tokens may include “<url>,” “<region>,” “<address>,” “<phone number>,” among others.

The term “UGC type” refers to any category, label, or classification of a UGC data component. The generic data token selected to replace a UGC data token is dependent on the UGC type of the UGC data token. For example, UGC data tokens comprising a service name, a product name, or a team name may be replaced with an index from the entity map storage corresponding to the specific service name, product name, or team name. In addition, some UGC data tokens may be replaced with a generic data token according to their UGC type. For example, URLs may be replaced with the generic data token “<url>.”

The term “data mutation process” refers to any operation or set of operations configured to modify input text string data, (e.g., alert message problem component, alert message auxiliary details component) such that the tokens are suited for feature extraction and/or machine learning model generation. Data mutation processes prepare the received text string to be better utilized by a feature extraction algorithm.

The term “non-linear transformation” refers to any modification, mutation, or alteration made to a data construct and/or other data object such that the original data construct may not be deduced from the resulting modified data construct. Vectorization algorithms such as word2vec and InferSent generate embeddings (e.g., alert message problem embeddings, alert message auxiliary detail embeddings) based on input data and are examples of non-linear transformations. Anonymizing data through the use of generic data tokens is another example of a non-linear transformation.

The term “bigram/trigram” refers to a string or other data construct comprising any combination of words and/or tokens appearing sequentially in a corpus, for example, the monitoring service alert corpus. While referred to as bigrams (2 words) and trigrams (3 words) any number of words may be combined to form an n-gram data construct.

The term “bigram list” refers to any set, list, dictionary, string, array, or other structure comprising one or more bigrams. The bigram list may further comprise an IDF or TF-IDF score associated with the bigram, indicating the importance of the bigram in a particular monitoring service alert and in the corpus.

The term “trigram list” refers to any set, list, dictionary, string, array, or other structure comprising one or more trigrams. The trigram list may further comprise an IDF or TF-IDF score associated with the trigram, indicating the importance of the trigram in a particular monitoring service alert and in the corpus.

The term “bigram word embeddings” refers to any data construct or data object resulting from a transformation performed on a bigram, formatting the bigram for entry into a machine learning model training module or classifier. The bigram word embedding is determined in part due to feature extraction, as described herein. For example, generating bigram word embeddings may include generating word embeddings on each bigram, using a word embedding technique, such as word2vec. A word embedding technique, produces a vector space based on the words contained in the corpus and/or received monitoring service alerts. The bigram may be mapped into the word space based on the context of the bigram string.

The term “trigram word embeddings” refers to any data construct or data object resulting from a transformation performed on a trigram, formatting the trigram for entry into a machine learning model training module or classifier. The trigram word embedding is determined in part due to feature extraction, as described herein. For example, generating trigram word embeddings may include generating word embeddings on each trigram, using a word embedding technique, such as word2vec. A word embedding technique, produces a vector space based on the words contained in the corpus and/or received monitoring service alerts. The trigram may be mapped into the word space based on the context of the trigram string.

The term “inverse document frequency (IDF) score” refers to any numerical value representing the frequency in which a particular token or string appears in a corpus (e.g., monitoring service alert corpus). An IDF score reflects the importance of a particular term, such as a word, token, bigram, trigram, etc. in a document (e.g., a text string and/or monitoring service alert) when considering the token within the corpus. For example, the IDF score for a particular term may be determined by logarithmically scaling the ratio of the number of documents in the corpus compared to the number of documents in which the term appears:

$$IDF ( T ) = log \frac{N}{{D}_{T}} ,$$

where T is a term, N is the number of documents in the corpus, and D_{T} is the number of documents in the corpus containing the term T. A term frequency-inverse document frequency (TF-IDF) score is calculated to provide a weighting of the IDF score based on the number of times a term appears within a particular document. For example, a TF-IDF score may be calculated as:

$$TF - IDF ( T ) = TF ( T ) * IDF ( T ) , \\ TF ( T ) = \frac{C ( T )}{{N}_{TERMS}} ,$$

where TF(T) is the term frequency of a term T within a document, C(T) is the total count of the term T within the document and N_{TERMS} is the total number of terms within the document.

The term “sentence embedding technique” refers to any algorithm or technique utilized to generate a data construct or data object formatted for entry into a machine learning model training module or classifier by representing entire sentences and their semantic information as vectors. A sentence embedding technique receives entire sentences from a document or text string (e.g., alert message auxiliary details component), such that the sentence embedding technique preserves the auxiliary details from the monitoring service alert when generating a machine learning model. Examples of sentence embedding techniques may include but are not limited to algorithms such as universal sentence encoder (USE) and InferSent. In some embodiments, the transformation performed by the sentence embedding technique may be a non-linear transformation.

The term “pre-defined category” or “alert message category” refers to any category, classification, label, or group having particular shared characteristics. Alert message categories are defined to classify and group monitoring service alerts. For example, alert message categories for monitoring service alerts may include but are not limited to: “infrastructure,” “configuration changes,” “security and reliability,” “application performance,” “system outages,” and “other.” The classification of a monitoring service alert into a pre-defined category or alert message category affects various aspects of handling a particular monitoring service alert. For example, the priority of the monitoring service alert may be dependent on the pre-defined category associated with the monitoring service alert. In addition, the responsible parties or entities and list of notified parties may be determined based on the monitoring service alert.

The terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

A “computer-readable storage medium,” which refers to a physical storage medium (e.g., volatile or non-volatile memory device), may be differentiated from a “computer-readable transmission medium,” which refers to an electromagnetic signal.

The terms “user”, “client”, and/or “request source” refer to an individual or entity that is a source, and/or is associated with sources, of a request for messages and/or related content to be provided by a message objective control system and/or any other system capable of providing messages and/or related content to the individual and/or entity. For example, a “user” and/or “client” may be the owner and/or entity that seeks information and options associated with preparing and/or otherwise planning for one or more potential events.

The term “database,” “resource,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

### Example System Architecture

Systems, computer program products, and methods of the present invention may be embodied by any of a variety of devices. For example, the systems and methods of an example embodiment may be embodied by a networked computing device (e.g., an enterprise software platform), such as a server or other network entity, configured to communicate with one or more devices, such as one or more client devices, one or more user devices, and one or more external services. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable computer, or any combination of the aforementioned devices.

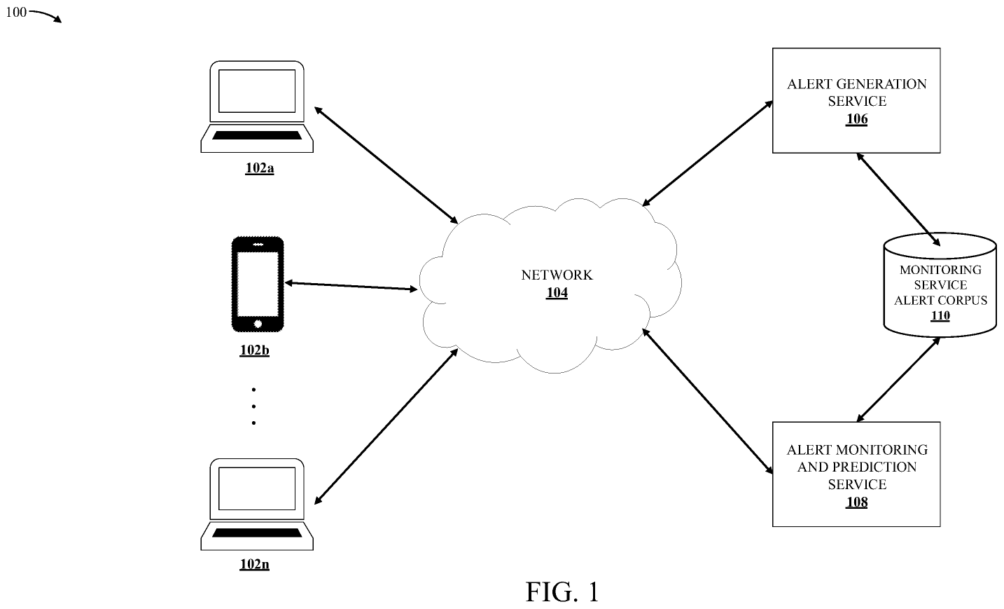

Referring now to FIG. 1, an example enterprise software platform 100 is provided. The example enterprise software platform 100 comprises a plurality of client devices 102a-102n, an alert generation service 106 and an alert monitoring and prediction service 108 each communicatively connected through a network 104. In addition, the alert monitoring and prediction service 108 and the alert generation service 106 are further communicatively connected to a monitoring service alert corpus 110 storage device.

As depicted in FIG. 1, the example enterprise software platform 100 includes a plurality of client devices 102a-102n. An example client device 102a-102n may include a mobile device, a smart phone, a tablet computer, a laptop computer, a wearable device, a personal computer, an enterprise computer, a virtual reality device, or another type of computing device. In one or more embodiments, a client device 102a-102n may be authorized to interface with other computing devices on the enterprise software platform 100 to view, modify, upload, download, and/or otherwise interact with files, libraries, and/or other objects. In one or more embodiments, a client device 102a-102n may further access alerts and incidents (e.g., a monitoring service alert) issued by the alert generation service 106 or stored on the alert monitoring and prediction service 108 and/or the monitoring service alert corpus 110. In addition, in some embodiments, a client device 102a-102n may enable the addition of UGC data components to a monitoring service alert. For example, a UGC data component may be hard coded in the client device to be automatically included in an alert attribute upon transmission of a particular monitoring service alert. In some embodiments, UGC data components may be added to a monitoring service alert by an operator or other user manually at a client device upon receipt of the monitoring service alert.

As further depicted in FIG. 1, the example enterprise software platform 100 includes a network 104. The alert generation service 106, the client devices 102a-102n, and/or the alert monitoring and prediction service 108 may be in communication using a network 104. Additionally, or alternatively, the alert generation service 106 and the alert monitoring and prediction service 108 may be in communication via a backend network and/or an enterprise network separate from the client devices 102a-102n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JavaScript Object Notation (JSON) objects sent via a WebSocket channel. In some embodiments, the protocol is JSON over RPC, JSON over REST/HTTP, the like, or combinations thereof.

As further depicted in FIG. 1, the example enterprise software platform 100 includes an alert generation service 106. An alert generation service 106 may be any software applications, services, microservices, features, hardware devices, firmware, and/or other similar mechanisms within an enterprise software platform 100 configured to generate and/or transmit incidents and alerts indicating the status of one or more components in an enterprise software platform 100 in the form of monitoring service alerts. An alert generation service 106 comprises a software service that is configured to detect alerts, warnings, problems, errors, issues, and/or incidents in the form of monitoring service alerts. In some embodiments, monitoring service alerts are generated based on triggering events. Triggering events initiating the transmission of an incident or alert may include user specified events, for example, the expiration of a timer or count, or the execution of a specific instruction or set of instructions in a software component. In some embodiments, triggering events may be related to the performance of the hardware and software components of the enterprise software network, for example, the shutdown of a device or component, low operating voltages and/or speeds of a component, an increase in latency of a hardware component, a change in security or accessibility, a change in resource utilization, and other similar events. In some embodiments, triggering events may be related to security threats, for example, unauthorized access to the system. In some embodiments, triggering events may be related to compliance issues, for example, a violation of data privacy. Further, in some embodiments, triggering events may be related to system failures, for example, an application crash, a down server, or a network connection lost. The alert generation service 106 may be further configured to transmit one or more monitoring service alerts to a communicatively connected monitoring service alert corpus 110 for training of a machine learning module.

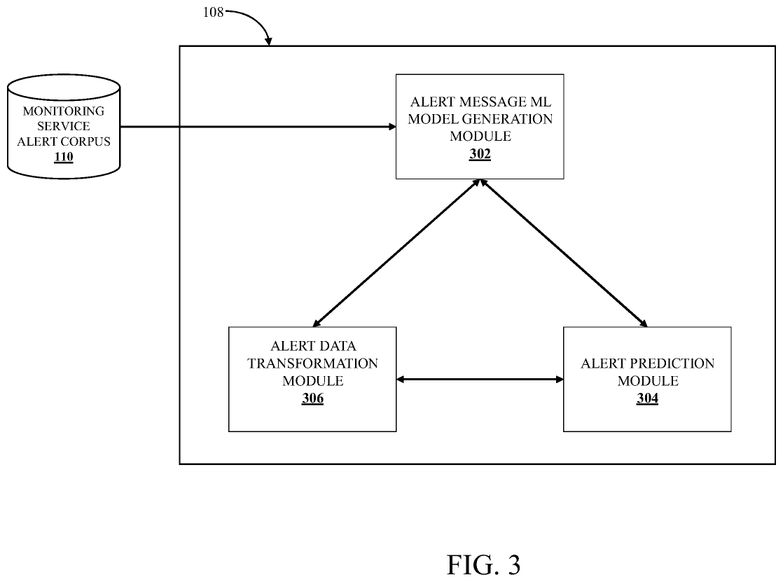

As further depicted in FIG. 1, the example enterprise software platform 100 includes an alert monitoring and prediction service 108 communicatively connected with a monitoring service alert corpus 110. An alert monitoring and prediction service may refer to any software service and associated hardware configured to monitor the operational state of one or more software applications, services, microservices, features, and/or other similar mechanisms within an enterprise software platform 100 through the receipt of monitoring service alerts. An alert monitoring and prediction service 108 may be used to categorize incidents and alerts, correlate sets of alerts, predict incidents, determine incident similarity, and/or locate any potential faults, among other things. An alert monitoring and prediction service 108 further comprises an alert message machine learning model generation module 302, an alert prediction module 304, and an alert data transformation module 306, as further depicted in relation to FIG. 3. As described herein, the alert message machine learning model generation module 302, the alert prediction module 304, and the alert data transformation module 306 enable the alert monitoring and prediction service 108 to train a machine learning model based on monitoring service alerts stored in the monitoring service alert corpus 110 and classify monitoring service alerts during operation.

The alert monitoring and prediction service 108, in the depicted embodiment, is further communicatively connected to a monitoring service alert corpus 110. The monitoring service alert corpus 110, as depicted may be any repository, store, compilation, or other similar collection of monitoring service alerts. The monitoring service alert corpus 110 may be utilized to train an alert message machine learning model in the alert monitoring and prediction service 108. The monitoring service alert corpus 110 may include historical alerts and/or alerts received during recent operation. Monitoring service alerts stored in the monitoring service alert corpus 110 may require transformation and/or conversion before use in the alert monitoring and prediction service.

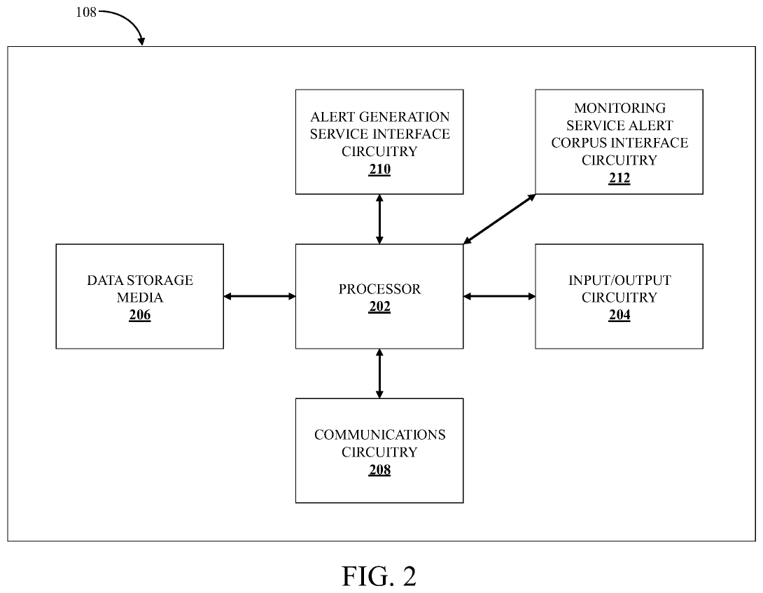

FIG. 2 illustrates an example alert monitoring and prediction service 108 in accordance with at least some example embodiments of the present disclosure. The alert monitoring and prediction service 108 includes processor 202, input/output circuitry 204, data storage media 206, communications circuitry 208, alert generation service interface circuitry 210, and monitoring service alert corpus interface circuitry 212. In some embodiments, the alert monitoring and prediction service 108 is configured, using one or more of the sets of circuitry 202, 204, 206, 208, 210, and/or 212, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the alert monitoring and prediction service 108 provide or supplement the functionality of other particular sets of circuitry. For example, the processor 202 in some embodiments provides processing functionality to any of the sets of circuitry, the data storage media 206 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the data storage media 206 via a bus for passing information among components of the alert monitoring and prediction service 108. In some embodiments, for example, the data storage media 206 is non-transitory and may include, for example, one or more volatile and/or non-volatile memories. In other words, for example, the data storage media 206 in some embodiments includes or embodies an electronic storage device (e.g., a computer readable storage medium). In some embodiments, the data storage media 206 is configured to store information, data, content, applications, instructions, or the like, for enabling the alert monitoring and prediction service 108 to carry out various functions in accordance with example embodiments of the present disclosure.

The processor 202 may be embodied in a number of different ways. For example, in some example embodiments, the processor 202 includes one or more processing devices configured to perform independently. Additionally, or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the alert monitoring and prediction service 108, and/or one or more remote or “cloud” processor(s) external to the alert monitoring and prediction service 108.

In an example embodiment, the processor 202 is configured to execute instructions stored in the data storage media 206 or otherwise accessible to the processor. Alternatively, or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively, or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with retrieving a monitoring service alert, wherein the monitoring service alert comprises a text string, including UGC text. Additionally, or alternatively, in some embodiments, the processor 202 includes hardware, software, firmware, and/or a combination thereof, configured to perform various operations associated with programmatically parsing the text string of the monitoring service alert to segregate the monitoring service alert into an alert message problem component and an alert auxiliary details component. Additionally, or alternatively, in some embodiments, the processor 202 includes hardware, software, firmware, and/or a combination thereof, configured to perform various operations associated with generating an alert message problem embedding by applying feature extraction to the alert message problem component. Additionally, or alternatively, in some embodiments, the processor 202 includes hardware, software, firmware, and/or a combination thereof, configured to perform various operations associated with generating an alert message description embedding by applying feature extraction to the alert auxiliary details component. Additionally, or alternatively, in some embodiments, the processor 202 includes hardware, software, firmware, and/or a combination thereof, configured to perform various operations associated with outputting UGC transformed alert data based on the alert message problem embedding and the alert message description embedding.

As another particular example embodiment, the processor 202 is configured to perform various operations associated with retrieving a monitoring service alert, wherein the monitoring service alert comprises a text string, including UGC text. Additionally, or alternatively, in some embodiments, the processor 202 includes hardware, software, firmware, and/or a combination thereof, configured to perform various operations associated with programmatically parsing the text string of the monitoring service alert to segregate the monitoring service alert into an alert message problem component and an alert auxiliary details component. Additionally, or alternatively, in some embodiments, the processor 202 includes hardware, software, firmware, and/or a combination thereof, configured to perform various operations associated with generating an alert message problem embedding by applying feature extraction to the alert message problem component. Additionally, or alternatively, in some embodiments, the processor 202 includes hardware, software, firmware, and/or a combination thereof, configured to perform various operations associated with generating an alert message description embedding by applying feature extraction to the alert auxiliary details component. Additionally, or alternatively, in some embodiments, the processor 202 includes hardware, software, firmware, and/or a combination thereof, configured to perform various operations associated with classifying a monitoring service alert in a pre-defined category based at least in part on an alert message machine learning model. Additionally, or alternatively, in some embodiments, the processor 202 includes hardware, software, firmware, and/or a combination thereof, configured to perform various operations associated with updating the alert message machine learning model based on feedback from one or more users.

As another particular example embodiment, the processor 202 is configured to perform various operations associated with retrieving a monitoring service alert, wherein the monitoring service alert comprises a text string, including UGC text. Additionally, or alternatively, in some embodiments, the processor 202 includes hardware, software, firmware, and/or a combination thereof, configured to perform various operations associated with identifying one or more UGC data components of the text string of the monitoring service alert corresponding to the UGC text. Additionally, or alternatively, in some embodiments, the processor 202 includes hardware, software, firmware, and/or a combination thereof, configured to perform various operations associated with replacing each of the one or more UGC data components with one or more generic data tokens based at least in part on a UGC type of the UGC data component. Additionally, or alternatively, in some embodiments, the processor 202 includes hardware, software, firmware, and/or a combination thereof, configured to perform various operations associated with programmatically parsing the text string of the monitoring service alert to segregate the monitoring service alert into an alert message problem component and an alert auxiliary details component. Additionally, or alternatively, in some embodiments, the processor 202 includes hardware, software, firmware, and/or a combination thereof, configured to perform various operations associated with generating an alert message problem embedding by applying feature extraction to the alert message problem component. Additionally, or alternatively, in some embodiments, the processor 202 includes hardware, software, firmware, and/or a combination thereof, configured to perform various operations associated with generate an alert message problem embedding by applying feature extraction to the alert message problem component. Additionally, or alternatively, in some embodiments, the processor 202 includes hardware, software, firmware, and/or a combination thereof, configured to perform various operations associated with generating an alert message description embedding by applying feature extraction to the alert auxiliary details component. Additionally, or alternatively, in some embodiments, the processor 202 includes hardware, software, firmware, and/or a combination thereof, configured to perform various operations associated with outputting UGC transformed alert data based on the alert message problem embedding and the alert message description embedding.

In some embodiments, the alert monitoring and prediction service 108 includes input/output circuitry 204 that provides output to the user and, in some embodiments, to receive an indication of a user input. In some embodiments, the input/output circuitry 204 is in communication with the processor 202 to provide such functionality. The input/output circuitry 204 may comprise one or more user interface(s) (e.g., user interface) and in some embodiments includes a display that comprises the interface(s) rendered as a web user interface, an application user interface, a user device, a backend system, or the like. The processor 202 and/or input/output circuitry 204 comprising the processor may be configured to control one or more functions of one or more user interface elements through computer program instructions (e.g., software and/or firmware) stored on a memory accessible to the processor (e.g., data storage media 206, and/or the like). In some embodiments, the input/output circuitry 204 includes or utilizes a user-facing application to provide input/output functionality to a client device and/or other display associated with a user.

In some embodiments, the alert monitoring and prediction service 108 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the alert monitoring and prediction service 108. In this regard, the communications circuitry 208 includes, for example in some embodiments, a network interface for enabling communications with a wired or wireless communications network. Additionally, or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device in communication with the alert monitoring and prediction service 108.

The alert generation service interface circuitry 210 includes hardware, software, firmware, and/or a combination thereof, that supports various functionality associated with interfacing with the alert generation service 106. For example, in some embodiments, the alert generation service interface circuitry 210 may include hardware, software, firmware, and/or a combination thereof, to receive monitoring service alerts and associated metadata from each of the devices in the alert generation service 106 and transmit necessary response data. In some embodiments, the alert generation service interface circuitry 210 may include hardware, software, firmware, and/or a combination thereof, to configure the generation of monitoring service alerts, for example, configuring the timing and content of monitoring service alerts.

The monitoring service alert corpus interface circuitry 212 includes hardware, software, firmware, and/or a combination thereof, that supports various functionality associated with reading and/or storing monitoring service alerts in the monitoring service alert corpus 110. For example, the monitoring service alert corpus interface circuitry 212 may read saved historical and/or real-time monitoring service alerts in order to generate an accurate machine learning model.

Additionally, or alternatively, in some embodiments, one or more of the sets of circuitry 202-212 are combinable. Additionally, or alternatively, in some embodiments, one or more of the sets of circuitry perform some or all of the functionality described associated with another component. For example, in some embodiments, one or more sets of circuitry 202-212 are combined into a single module embodied in hardware, software, firmware, and/or a combination thereof. Similarly, in some embodiments, one or more of the sets of circuitry, for example alert generation service interface circuitry 210, and/or monitoring service alert corpus interface circuitry 212, is/are combined such that the processor 202 performs one or more of the operations described above with respect to each of these circuitry individually.

Referring now to FIG. 3, an example alert monitoring and prediction service 108 is provided. As depicted in FIG. 3, the example alert monitoring and prediction service 108 includes at least three interconnected modules, an alert message machine learning model generation module 302, an alert prediction module 304, and an alert data transformation module 306. In addition, the alert monitoring and prediction service 108, as shown, is communicatively connected to the monitoring service alert corpus 110.

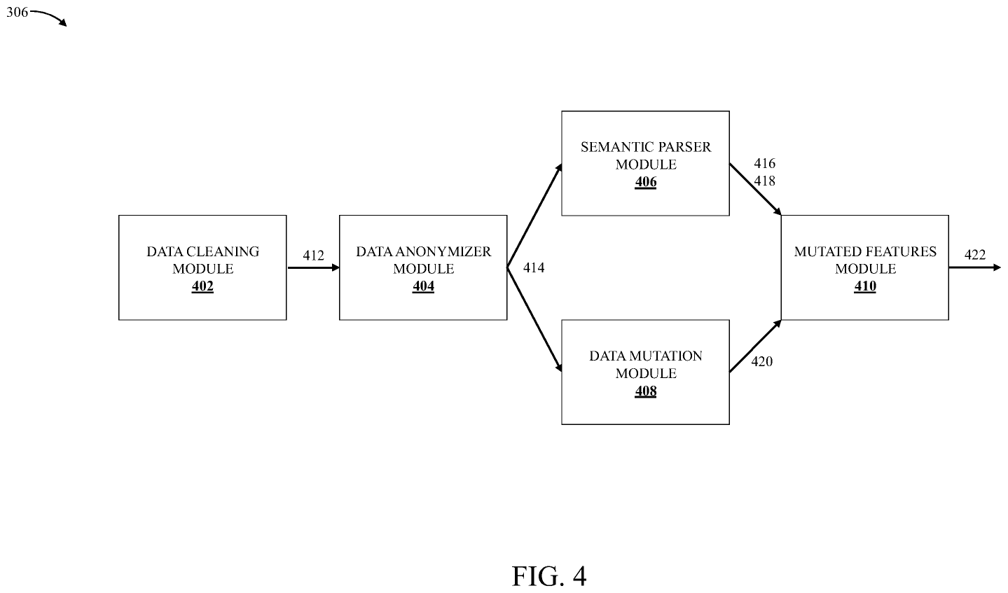

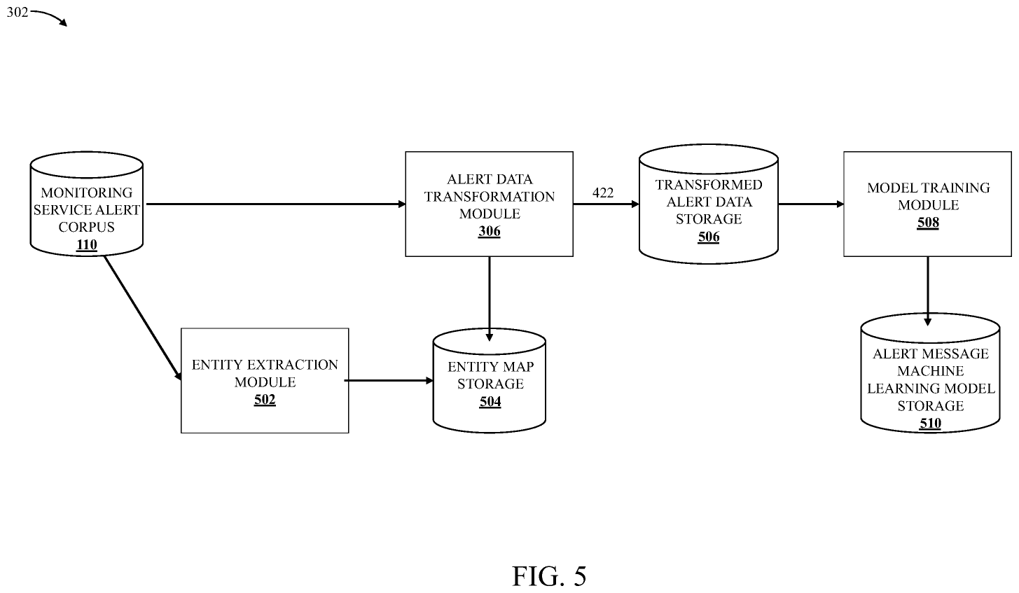

As depicted in FIG. 3, the example alert monitoring and prediction service 108 includes an alert message machine learning model generation module 302. The depicted alert message machine learning model generation module 302 utilizes a corpus of monitoring service alerts, some of which may be stored in the monitoring service alert corpus 110, to generate and train a machine learning model used to classify received monitoring service alerts. In order to prepare the data within the monitoring service alert (potentially including UGC), the alert message machine learning model generation module 302 utilizes one or more aspects of the alert data transformation module 306, as further described in relation to FIG. 4. In addition, during operation of the enterprise software platform 100, the alert prediction module 304 utilizes one or more of the machine learning models produced by the alert message machine learning model generation module 302. Further details regarding the internal components of the alert message machine learning model generation module 302 are included in relation to FIG. 5.

As further depicted in FIG. 3, the example alert monitoring and prediction service 108 includes an alert data transformation module 306. An alert data transformation module 306 may be any software, hardware, firmware, and/or combination thereof configured to receive monitoring service alerts and generate UGC transformed alert data based on the received monitoring service alert. As shown in the depicted embodiment of FIG. 3, in some instances, the monitoring service alert may come from the monitoring service alert corpus 110 containing historic monitoring service alerts. The monitoring service alerts originating from the monitoring service alert corpus 110 may be transmitted to the alert data transformation module 306 via the alert message machine learning model generation module 302. As further depicted in the embodiment of FIG. 3, in some instances, monitoring service alerts in the form of real-time monitoring service alerts may be transmitted to the alert data transformation module 306 by the alert prediction module 304. Further details regarding the internal components of the alert data transformation module 306 are included in relation to FIG. 4.

As further depicted in FIG. 3, the example alert monitoring and prediction service 108 includes an alert prediction module 304. The alert prediction module 304 may receive monitoring service alerts during the operation of the enterprise software platform 100 and perform actions based on predictions determined from the received monitoring service alert. Actions may include but are not limited to alerting a person, entity, or device of the incident or alert; applying mitigating actions such as reducing power to a component, disabling a component, enabling a back-up or alternate component; providing a visual indicator through a physical mechanism and/or a user interface; enabling or disabling a system setting; or other similar actions. For example, an alert prediction module 304 may receive a system alert through a monitoring service alert. The alert prediction module 304 may determine the monitoring system alert is indicative of a security breach on a server. The alert prediction module 304 may then cause the information technology (IT) team in charge of security breaches to be notified. The alert prediction module 304 may further cause the power and/or connectivity to the server to be disabled. The alert prediction module 304 may further cause a back-up server to be enabled.

Referring now to FIG. 4, an example alert data transformation module 306 is provided. As shown in FIG. 4, the example alert data transformation module 306 provides a data path including a plurality of modules that transform the input data (e.g., monitoring service alerts) into UGC transformed alert data 422. The UGC transformed alert data 422 results from one or more non-linear transformations on the monitoring service alerts. The non-linear transformations ensure the monitoring service alert cannot be discerned from the resulting UGC transformed alert data 422. The depicted data path includes a data cleaning module 402 which receives the one or more monitoring service alerts and produces a bag-of-words set 412. The data anonymizer module 404, receives the bag-of-words set 412 and performs anonymizing functions to produce an anonymized incident text list 414. From the data anonymizer module 404 the anonymized incident text list 414 is transmitted to a semantic parser module 406 and a data mutation module 408. The semantic parser module 406 produces two lists, an alert message problem component 416 containing tokens from the monitoring service alert related to the reported problems, and an alert message auxiliary details component 418 containing tokens from the monitoring service alert related to the details of the problem. In some embodiments, the alert message problem component may comprise portions of the title and/or description of the monitoring service alert. In some embodiments, all words or tokens of the title and/or description not classified as an alert message problem component may be included in the alert message auxiliary details component. The data mutation module 408 produces a cleaned token list 420 in which transformations such as lemmatization and stopword removal have been performed on the anonymized incident text list 414. The mutated features module 410 receives the alert message problem component 416, the alert message auxiliary details component 418, and the cleaned token list 420, performs feature extraction, and produces the UGC transformed alert data 422.

As depicted in FIG. 4, the example alert data transformation module 306 includes a data cleaning module 402. The data cleaning module 402 may be any hardware, software, firmware, or combination thereof, configured to break-down, or tokenize the input monitoring service alert to create a sequence of tokens or bag-of-words set 412, representing the words in the monitoring service alert. In some embodiments, the data cleaning module 402 may tokenize the monitoring service alert text, including at least the title and description, based on specific delimiters (e.g., “,”, “;”, “,”, “=”). The data cleaning module 402 may generate the bag-of-words set 412 comprising a collection of tokens transmitted as part of the monitoring service alert. The bag-of-words set 412 may include a list, set, dictionary, or other data structure comprising the bag-of-words to be transmitted to the data anonymizer module 404.

As further depicted in FIG. 4, the example alert data transformation module 306 includes a data anonymizer module 404. The data anonymizer module 404 may be any hardware, software, firmware, or combination thereof, configured to receive a tokenized set of words and/or phrases (e.g., bag-of-words set 412) derived from the monitoring service alert and tokenized according to one or more delimiters by the data cleaning module 402. The data anonymizer module 404 may generate an anonymized incident text list 414 in the form of a dictionary, set, or other data object, wherein certain UGC tokens from the incident text list are replaced with non-identifying placeholders according to the UGC type.

For example, a token of the bag-of-words set 412 may refer to specific objects, such as URLs, times, locations, regions, and other specific references. A generic data token may be used to replace a specific reference in a UGC data component with a generic tag. As an example, a text string may include a time, for example, 5 seconds. A generic data token selected to replace the specific time “5 seconds” may be “<time>.” Other generic data tokens may include “<url>,” “<region>,” “<address>,” and “<phone number>,” among others. The resulting token list with anonymized data tokens may be referred to as the anonymized incident text list 414 and as depicted in the example embodiment of FIG. 4, the anonymized incident text list may be transmitted to the semantic parser module 406 and the data mutation module 408.

In some embodiments, the data anonymizer module 404 may determine a UGC type, and anonymize the data based on the UGC type. For example, UGC data tokens comprising a service name, a product name, or a team name may be replaced with an index from the entity map storage corresponding to the specific service name, product name, or team name. In addition, some UGC data tokens may be replaced with a generic data token according to their UGC type. For example, a monitoring service alert may include tokens referring to specific objects, such as URLs, times, locations, regions, and other specific references. A generic data token may be used to replace a specific reference in a UGC data component with a generic tag. As an example, monitoring service alert may include a time, for example, 5 seconds. A generic data token selected to replace the specific time “5 seconds” may be “<time>.” Other generic data tokens may include “<url>,” “<region>,” “<address>,” “<phone number>,” among others.

As further depicted in FIG. 4, the example alert data transformation module 306 includes a semantic parser module 406. The semantic parser module 406 may be any software, hardware, firmware, or combination thereof configured to receive an anonymized incident text list 414, parse the text list using one or more semantic parsers, and generate an alert message problem component 416 and an alert message auxiliary details component 418. As depicted in FIG. 4, the semantic parser module 406 utilizes a semantic parsing method to determine the tokens of the anonymized incident text list 414 that relate to identifying the problem reported by the monitoring service alert. A semantic parser generates a problem token list, comprising the list of tokens from the anonymized incident text list 414 related to the reported problem. The semantic parser further identifies tokens from the anonymized incident text list 414 related to the description of the problem reported by the monitoring service alert and generates an alert message auxiliary details component 418 comprising descriptive tokens. Semantic parsers may include but are not limited to an ESG parser, a Bi-LSTM CRF parser, or other similar semantic parsers. Separating the tokens of the monitoring service alerts enables the alert monitoring and prediction service 108 to create separate embeddings during training and classification: an alert message problem embedding and an alert message description embedding. Separate embeddings for the problem and the description enable separate non-linear transformations to be performed, each tailored to utilize the specific type of data.

As further depicted in FIG. 4, the example alert data transformation module 306 includes a data mutation module 408. A data mutation module 408 may be any software, hardware, firmware, or any combination thereof, configured to receive a set of tokens (e.g., anonymized incident text list 414) and perform a data mutation process to prepare the data for feature extraction at the mutated features module 410. Although depicted in FIG. 4 as receiving anonymized incident text list 414 from the data anonymizer module 404, in some embodiments, the data mutation module 408 may receive the alert message problem component 416 and the alert message auxiliary details component 418 from the semantic parser module 406 and perform mutation operations on the parsed data. However, performing the data mutation process of the data mutation module 408 in parallel with the parsing operations performed by the semantic parser module 406 may enable improvements in latency in generating UGC transformed alert data 422 from a received monitoring service alert. In an instance in which the data mutation process of the data mutation module 408 is performed in parallel to the parsing operations of the semantic parser module 406, the data mutations may be applied to the parsed data previous to the generation of embeddings in the mutated features module 410.

In addition, the data mutation module 408 may be configured to perform a data mutation process as described herein. For example, the data mutation process may include one or more natural language processing transformations on the input tokens. For example, a data mutation process may be configured to perform stopword removal. A stopword removal algorithm may be configured to remove words and/or phrases contained in a pre-determined stopword list. For example, a stopword list may include stopwords such as “the,” “in,” “on,” “regards,” “good morning,” etc. The data mutation process may additionally or alternatively be configured to perform lemmatization of the text string tokens. In some embodiments, lemmatization may be utilized to reduce a text string token to the base form or root of the word. Each of these operations better prepares the tokens for feature extraction performed by the mutated features module 410.

As further depicted in FIG. 4, the example alert data transformation module 306 includes a mutated features module 410. A mutated features module 410 may include hardware, software, and/or firmware configured to receive one or more cleaned token lists 420 and perform various operations to extract features and determine a representative embedding for use in machine learning model training and classification. The alert data transformation module 306 may perform one or more non-linear transformations, as described herein. A non-linear transformation may be any modification, mutation, or alteration made to the monitoring service alert such that the original monitoring service alert may not be deduced from the resulting UGC transformed alert data 422. Non-linear transformations may include but are not limited to vectorization algorithms such as word2vec and InferSent.

In some embodiments, the mutated features module 410 may be configured to determine the alert message problem embeddings separate from the alert message auxiliary detail embeddings. For example, the alert message problem embeddings may be determined using word embedding techniques, in some instances, on bigrams/trigrams/n-grams. As such, the mutated features module 410 may be configured to determine and construct bigram, trigram, and n-gram data constructs. A bigram may comprise a combination of words and/or tokens appearing sequentially in a text string, for example, a monitoring service alert. A mutated features module 410 may combine 2 (bigram), 3 (trigram), or n (n-gram) tokens to form a single data construct. In some embodiments, a bigram/trigram/n-gram may be concatenated into a single string with the tokens separated by an underscore. The bigram/trigram/n-gram may further be compiled into a bigram/trigram/n-gram list. Bigram/trigram/n-gram word embeddings may then be performed on the bigram/trigram/n-gram list. Determining embeddings on bigram/trigram/n-gram lists preserves context for common phrases while calculating an embedding for the monitoring service alert.

In some embodiments, the mutated features module 410 may be configured to determine separate embeddings for the alert message auxiliary details component 418. For example, the mutated features module 410 may utilize sentence embedding techniques to determine a sentence embedding for the alert message auxiliary details component 418. A sentence embedding technique receives entire sentences, utilizing information across the entire input text string while preserving time and space during operation of the enterprise software platform 100.

The mutated features module 410 may further calculate an inverse document frequency score (IDF) score for the words, bigrams, trigram, and n-grams within a monitoring service alert. The IDF score may be based on the monitoring service alert corpus 110 maintained within the enterprise software platform 100. As described herein, the IDF score may represent the importance of a particular term, phrase, or sentence in a corpus, or collection of monitoring service alerts.

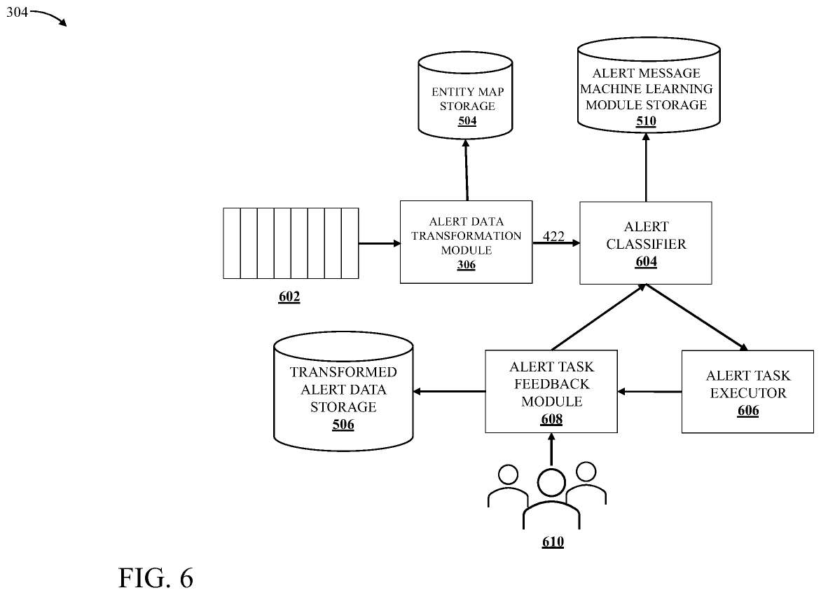

As further depicted in FIG. 4, the example alert data transformation module 306 outputs or stores the UGC transformed alert data 422. The UGC transformed alert data 422 is a non-linear transformation of the input monitoring service alert, thus, the original monitoring service alert and correlated UGC data cannot be determined from the UGC transformed alert data 422. The UGC transformed alert data 422, in some embodiments, may be stored in UGC transformed alert data storage 506 as described further in relation to FIG. 5. Additionally, or alternatively, the UGC transformed alert data 422 may be utilized by an alert classifier 604 as further described in relation to FIG. 6.

Referring now to FIG. 5, an example alert message machine learning model generation module 302 is provided. As depicted in FIG. 5, the example alert message machine learning model generation module 302 includes access to a monitoring service alert corpus 110. Monitoring service alerts from the monitoring service alert corpus 110 are retrieved by an entity extraction module 502 for purposes of identifying entities within the monitoring service alert and storing the entities and an associated value in an entity map storage 504. As further depicted in FIG. 5, an alert data transformation module 306 retrieves monitoring service alerts from the monitoring service alert corpus 110 in order to train a machine learning model. As described herein, the alert data transformation module 306 may transform the retrieved monitoring service alerts such that certain data within the monitoring service alert (e.g., UGC) is removed and the original data cannot be claimed based on access to the UGC transformed alert data 422. The alert data transformation module 306 may utilize the entity map storage 504 to further obfuscate UGC data, such as entities. As depicted, once generated, the UGC transformed alert data 422 is stored in the UGC transformed alert data storage 506. As further depicted in FIG. 5, the UGC transformed alert data 422 is retrieved from the UGC transformed alert data storage 506 by a model training module 508. The model training module 508 generates and trains one or more training models for use with the enterprise software platform 100. The one or more training models are stored in the alert message machine learning model storage 510 for use during classification.

As depicted in FIG. 5, the alert message machine learning model generation module 302 includes an entity extraction module 502. The entity extraction module 502 may identify UGC data, including entities such as deployed services, products, team names, and other entity names. The entity extraction module may develop an entity map by creating a key-value pair for each unique entity extracted, wherein the key is the unique entity name, and the value is a list of indexes. The entity extraction module 502 may subsequently store the list of key-value pairs as an entity index map in an entity map storage 504. The entity map may be retrieved from entity map storage by the data anonymizer module 404 during alert message machine learning model generation and during alert message classification. For example, the data anonymizer module 404 may identify entities in the bag-of-words set 412 and replace entities found in the entity map storage 504 with an associated index, thus, masking the identity of the entities disclosed in the monitoring service alert.

As further depicted in FIG. 5, the alert message machine learning model generation module 302 includes a UGC transformed alert data storage 506. The UGC transformed alert data storage 506 may be any storage element or device configured to hold UGC transformed alert data 422 from one or more monitoring service alerts. The UGC transformed alert data storage 506 may be accessible to the model training module 508 and updateable by the alert task feedback module 608 as described in relation to FIG. 6.

As further depicted in FIG. 5, the alert message machine learning model generation module 302 includes a model training module 508. The model training module 508 may be any data construct that is configured to generate and update an alert message machine learning model. The alert message machine learning model may be generated and updated based on monitoring service alerts processed from the monitoring service alert corpus 110 and/or monitoring service alerts received during real-time operation of the enterprise software platform 100. In addition, the UGC transformed alert data 422 stored in the UGC transformed alert data storage 506 and the resulting machine learning model may be updated based on feedback from the user as further described in relation to FIG. 6.

As further depicted in FIG. 5, the alert message machine learning model generation module 302 includes an alert message machine learning model storage 510. The alert message machine learning model storage 510 may be any storage element or device configured to hold one or more machine learning models generated based on one or more monitoring service alerts. The alert message machine learning model storage 510 may be accessible by the alert classifier 604 as further described in relation to FIG. 6.

Referring now to FIG. 6, an example alert prediction module 304 is provided. As shown in FIG. 6, the example alert prediction module 304 receives real-time monitoring service alerts 602 from the alert generation service 106. The example alert prediction module 304 further comprises an alert data transformation module 306 configured to receive real-time monitoring service alerts 602. In addition, the depicted alert data transformation module accesses entity maps from entity map storage 504. The alert data transformation module 306 produces UGC transformed alert data 422. The alert classifier 604 retrieves a machine learning model from the alert message machine learning model storage 510 and the UGC transformed alert data 422 from the alert data transformation module 306 and classifies the received monitoring service alert. The alert prediction module 304 further comprises an alert task executor 606 configured to execute a task based on the classification of the received monitoring service alert. Further, the alert prediction module 304 further provides an alert task feedback module 608 through which users 610 may provide feedback as it relates to the classification of the real-time monitoring service alert and associated tasks. Feedback from the one or more users 610 may be used to or update the UGC transformed alert data storage 506, the alert classifier 604, or both.

As depicted in FIG. 6, the alert prediction module 304 receives real-time monitoring service alerts 602. Real-time monitoring service alerts 602 may be any monitoring service alert received by the alert prediction module 304 during operation. In some embodiments, the real-time monitoring service alerts 602 may be generated by the alert generation service 106 and/or by an alert monitoring and prediction service 108. The real-time monitoring service alerts 602 may be queued or otherwise stored while awaiting handling by the alert prediction module 304.

As further depicted in FIG. 6, the alert prediction module 304 includes an alert data transformation module 306. As described in relation to FIG. 3, the alert data transformation module 306 may receive real-time monitoring service alerts 602 and access the entity map storage 504 to produce UGC transformed alert data 422.

As further depicted in FIG. 6, the example alert prediction module 304 includes an alert classifier 604. An alert classifier may be any software, firmware, hardware, or any combination thereof, configured to sort a real-time monitoring service alert 602 into a pre-defined category, based on the monitoring service alert and the pre-determined machine learning model stored in the alert message machine learning model storage 510.

As further depicted in FIG. 6, the example alert prediction module 304 includes an alert task executor 606. The alert task executor 606 may be any hardware, software, firmware, or combination thereof, configured to execute one or more tasks based on the pre-defined category of the real-time monitoring service alert 602. A monitoring service alert may include indicators regarding the performance of a component (e.g., whether the component and its functions are running at peak speed or slower than peak speed, if certain functions or capabilities are not running at peak performance or not running at all, etc.). The alert task executor 606 may perform actions based on the content of the monitoring service alert. For example, actions may include but are not limited to alerting a person, entity, or device of the incident or alert; applying mitigating actions such as reducing power to a component, disabling a component, enabling a back-up or alternate component; providing a visual indicator through a physical mechanism and/or a user interface; enabling or disabling a system setting; or other similar actions.

As further depicted in FIG. 6, the example alert prediction module 304 may include an alert task feedback module 608. The depicted alert task feedback module 608 provides a way for users to introduce feedback as it relates to the classified pre-defined category for a particular real-time monitoring service alert 602 and/or for an action taken based on the classified pre-defined category. In some instances, the feedback may be utilized to update the UGC transformed alert data 422 stored in the UGC transformed alert data storage 506. In some embodiments, the user feedback may be utilized to update one or more machine learning models stored I the alert message machine learning model storage 510.

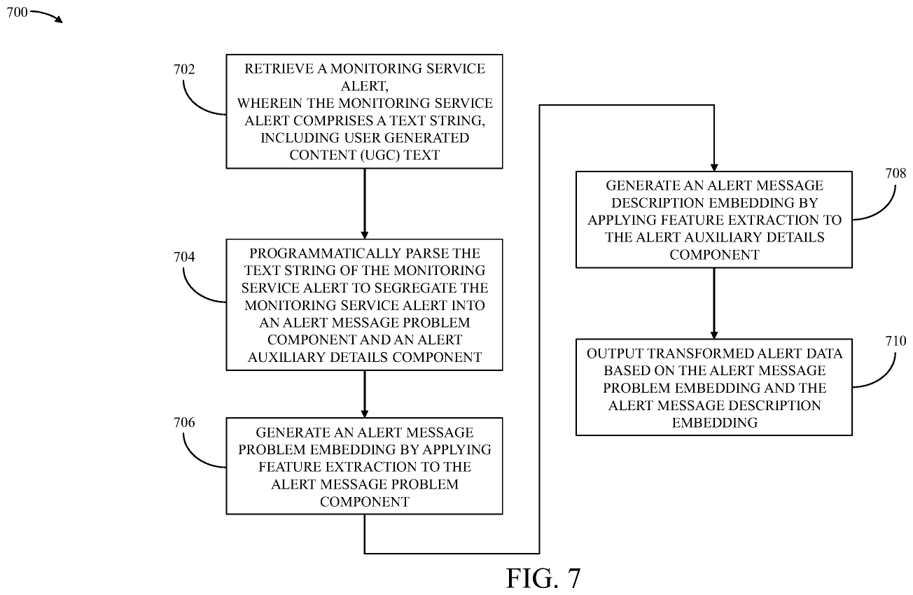

Referring now to FIG. 7, an example process 700 for outputting UGC transformed alert data (e.g., UGC transformed alert data 422) conditioned for use in creating a machine learning model and/or classifying real-time monitoring service alerts, is provided. At block 702, an alert monitoring and prediction service (e.g., alert monitoring and prediction service 108) retrieves a monitoring service alert, wherein the monitoring service alert comprises a text string, including user generated content (UGC) text. As described herein, a monitoring service alert may comprise text, for example, a title, and a description. In some embodiments, the text may partially or fully comprise UGC. UGC may contain restrictions, such as federal restrictions that prevent use of the UGC in generating machine learning models and classifying monitoring service alerts based on the data comprised therein.

At block 704, an alert monitoring and prediction service programmatically parses the text string of the monitoring service alert to segregate the monitoring service alert into an alert message problem component and an alert auxiliary details component. An alert message problem component may be any portion of the text within a monitoring service alert indicating the problem, symptom, issue, operational condition, or other triggering event indicated by the monitoring service alert. The alert auxiliary details component may refer to any and/or all details supporting the alert message problem component. In some embodiments, one or more semantic parsers may be utilized to segregate the monitoring service alert.

At block 706, an alert monitoring and prediction service generates an alert message problem embedding by applying feature extraction to the alert message problem component. As described herein, the alert message problem component may be transformed separate from the alert auxiliary details component. For example, an alert message problem embedding may be determined based on non-linear transformations such as feature extraction using a word embedding technique.

At block 708, an alert monitoring and prediction service generates an alert message description embedding by applying feature extraction to the alert auxiliary details component. The alert auxiliary details component may be transformed non-linearly through a sentence embedding or a similar technique. Thus, the context observed in the alert auxiliary details component may be preserved separately from the alert message problem component without using excessive space and/or time for less important details.

At block 710, an alert monitoring and prediction service outputs UGC transformed alert data based on the alert message problem embedding and the alert message description embedding. As described herein, the UGC transformed alert data (e.g., UGC transformed alert data 422) may be stored in UGC transformed alert data storage 506 for later use by a model training module. In addition, the UGC transformed alert data may be updated based on user feedback. Because the UGC transformed alert data has undergone a plurality of transformations (including non-linear transformations) to remove and otherwise obscure UGC, the original data, including the UGC may not be determined from the UGC transformed alert data.

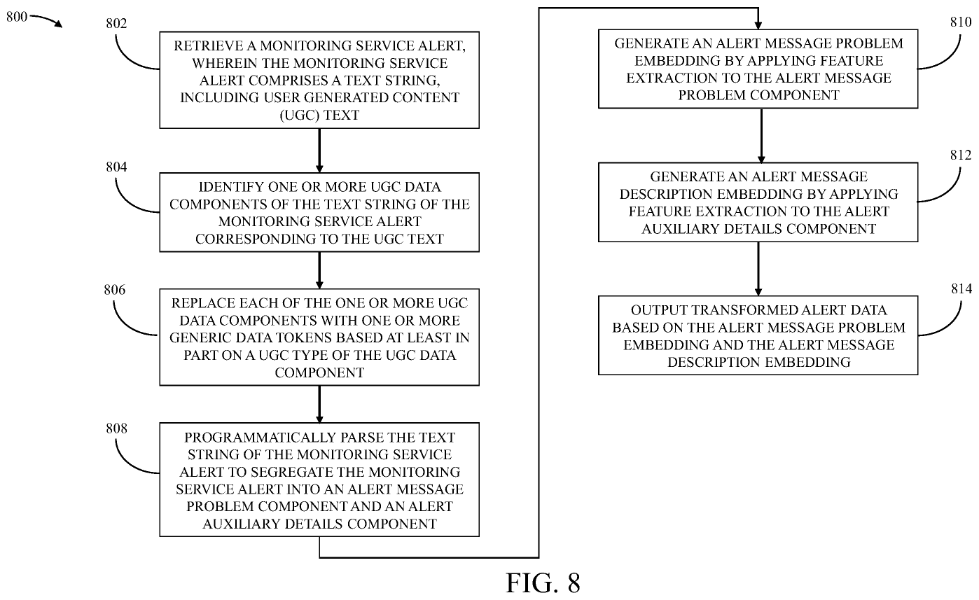

Referring now to FIG. 8, another example process 800 for outputting UGC transformed alert data (e.g., UGC transformed alert data 422) conditioned for use in creating a machine learning model and/or classifying real-time monitoring service alerts, is provided. At block 802, an alert monitoring and prediction service (e.g., alert monitoring and prediction service 108) retrieves a monitoring service alert, wherein the monitoring service alert comprises a text string, including user generated content (UGC) text. As described herein, a monitoring service alert may comprise text, for example, a title, and a description. In some embodiments, the text may partially or fully comprise UGC. UGC may contain restrictions, such as federal restrictions that prevent use of the UGC in generating machine learning models and classifying monitoring service alerts based on the data comprised therein.

At block 804, the alert monitoring and prediction service identifies one or more UGC data components of the text string of the monitoring service alert corresponding to the UGC text. In an instance in which the text string comprises a monitoring service alert, for example from a monitoring service alert corpus 110, the alert monitoring and prediction service may utilize an alert message machine learning model generation module (e.g., alert message machine learning model generation module 302) to identify named entities. Named entities may include any sequence of characters and/or tokens identifying a specific organization, service, team, etc. Named entities may include but are not limited to deployed services, products, team names, and other similar entities. Named entities may be identified by comparing the text string with a stored list, through semantic parsing, or through other similar mechanisms. Once identified, the named entity may be added to a list and/or dictionary of named entities in a key-value pair. Where the key is the name of the entity, and the value is a list of indices associated with that named entity. The list and/or dictionary, in some embodiments, may be store in the entity map storage 504 and accessed by the alert prediction module 304 during operation.

At block 806, the alert monitoring and prediction service replaces each of the one or more UGC data components with one or more generic data tokens based at least in part on a UGC type of the UGC data component. To further anonymize the monitoring service alerts, the alert monitoring and prediction service may utilize a data anonymizer module (e.g., data anonymizer module 404) of an alert data transformation module to identify the UGC data component. The data anonymizer module may categorize UGC according to UGC type. For example, UGC may be added to a monitoring service alert by an administrator with access to the enterprise software platform, by a user of a client device, or by anyone else with access to a device on the enterprise software network. UGC may include personal identifiable data, such as names, phone numbers, email addresses, addresses, and so on. In addition, UGC may include locations, dates, times, URLs, or other data that may be generalized as part of the generation of UGC transformed alert data. In some instances, regulations may exist regarding the use of UGC data in training a machine learning module. The data anonymizer module may identify the UGC type by comparing the text string with a stored list of known UGC, through semantic parsing, through regular expression parsing, or through other similar mechanisms. Depending on the UGC type, the data anonymizer module may perform different actions to obscure the UGC data while utilizing the context provided by the UGC. For example, UGC data tokens comprising a service name, a product name, or a team name may be replaced with an index from the entity map storage corresponding to the specific service name, product name, or team name as described above. In addition, some UGC data tokens may be replaced with a generic data token according to their UGC type. For example, URLs may be replaced with the generic data token “<url>.”

At block 808, the alert monitoring and prediction service programmatically parses the text string of the monitoring service alert to segregate the monitoring service alert into an alert message problem component and an alert auxiliary details component. An alert message problem component may be any portion of the text within a monitoring service alert indicating the problem, symptom, issue, operational condition, or other triggering event indicated by the monitoring service alert. The alert auxiliary details component may refer to any and/or all details supporting the alert message problem component. In some embodiments, one or more semantic parsers may be utilized to segregate the monitoring service alert.

At block 810, the alert monitoring and prediction service generates an alert message problem embedding by applying feature extraction to the alert message problem component. As described herein, an alert message problem embedding may be determined based on non-linear transformations such as feature extraction using a word embedding technique.

At block 812, the alert monitoring and prediction service generates an alert message description embedding by applying feature extraction to the alert auxiliary details component. The alert auxiliary details component may be subject to one or more non-linear transformations, such as a sentence embedding or a similar embedding technique. Thus, the context observed in the alert auxiliary details component may be preserved separately from the alert message problem component without using excessive space and/or time for less important details.

At block 814, the alert monitoring and prediction service outputs UGC transformed alert data based on the alert message problem embedding and the alert message description embedding. As described herein, the UGC transformed alert data (e.g., UGC transformed alert data 422) may be stored in UGC transformed alert data storage 506 for later use by a model training module. In addition, the UGC transformed alert data may be updated based on user feedback. Because the UGC transformed alert data has undergone a plurality of transformations (including non-linear transformations) to remove and otherwise obscure UGC, the original data, including the UGC may not be determined from the UGC transformed alert data.

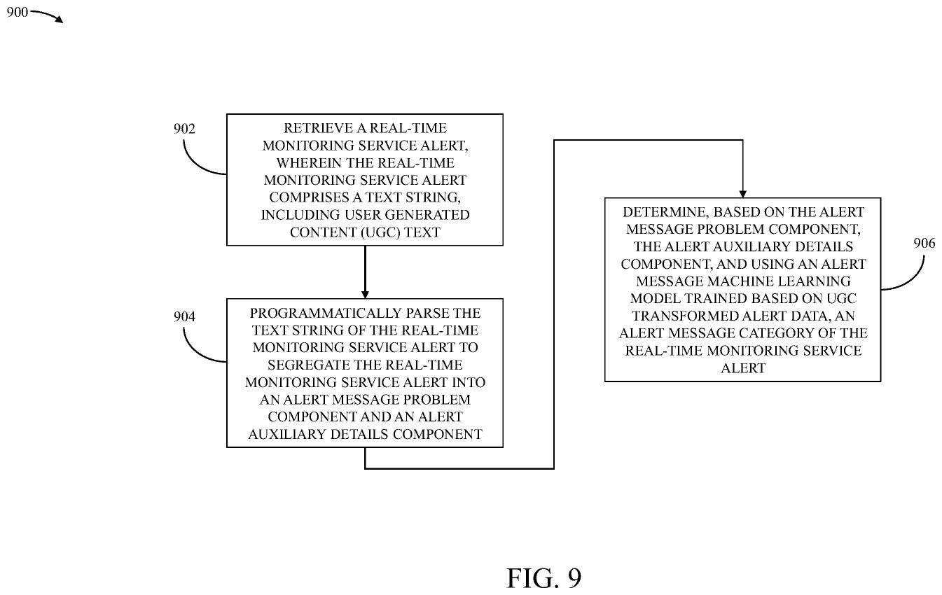

Referring now to FIG. 9, an example process 900 for categorizing a real-time monitoring service alert (e.g., real-time monitoring service alert 602) based on a machine learning model is provided. At block 902, an alert monitoring and prediction service (e.g., alert monitoring and prediction service 108) retrieves a real-time monitoring service alert, wherein the real-time monitoring service alert comprises a text string, including user generated content (UGC) text. As described herein, a real-time monitoring service alert may comprise text, for example, a title, and a description. In some embodiments, the text may partially or fully comprise UGC. The use of UGC may be subject to restrictions, such as federal restrictions that prevent use of the UGC in generating machine learning models and classifying monitoring service alerts based on the data comprised therein, unless the data is first modified or transformed.

At block 904, the alert monitoring and prediction service programmatically parses the text string of the real-time monitoring service alert to segregate the real-time monitoring service alert into an alert message problem component and an alert auxiliary details component. An alert message problem component may be any portion of the text within a monitoring service alert indicating the problem, symptom, issue, operational condition, or other triggering event indicated by the real-time monitoring service alert. The alert auxiliary details component may refer to any and/or all details supporting the alert message problem component. As described herein, in some embodiments, one or more semantic parsers may be utilized to segregate the monitoring service alert.

At block 906, the alert monitoring and predictions service determines, based on the alert message problem component, the alert auxiliary details component, and using an alert message machine learning model trained based on UGC transformed alert data, an alert message category of the real-time monitoring service alert

In some embodiments, the alert monitoring and prediction service generates an alert message problem embedding by applying feature extraction to the alert message problem component. As described herein, an alert message problem embedding may be determined based on non-linear transformations such as feature extraction using a word embedding technique.

In some embodiments, the alert monitoring and prediction service generates an alert message description embedding by applying feature extraction to the alert auxiliary details component. The alert auxiliary details component may be subject to one or more non-linear transformations, such as a sentence embedding or a similar embedding technique. Thus, the context observed in the alert auxiliary details component may be preserved separately from the alert message problem component without using excessive space and/or time for less important details.

In some embodiments, the alert monitoring and prediction service may determine an alert message category based at least in part on an alert message machine learning model, generated and stored in an alert message machine learning model storage (e.g., alert message machine learning model storage 510). The alert message machine learning model may further be determined based on the UGC transformed alert data. The alert message categories may include but are not limited to “infrastructure,” “configuration changes,” “security and reliability,” “application performance,” “system outages,” and “other.” In some embodiments, additional pre-defined categories may be added, for example through user feedback as described herein, as alert message categories.

In some embodiments, the alert message machine learning model may comprise a support vector machine (SVM), machine learning model. The SVM may be trained using a training set of UGC transformed data, such as the UGC transformed data generated from monitoring service alerts in the monitoring service alert corpus. In addition, the SVM training model may be updated based on user feedback. In practice, the SVM may identify a hyperplane or kernel function to map the input features of the monitoring service alerts into a multi-dimensional space. The kernel function or hyperplane may indicate the classification of a received monitoring service alert based on the location in the feature space.

In some embodiments, the alert message machine learning model may comprise a multi-layer perceptron (MLP) machine learning model. The MLP machine learning model may consist of an artificial neural network of nodes. Each node of the network of nodes may generate an output based on the weighted sum of inputs using a sigmoid, rectified linear unit, or similar function. The weights and biases of each node may be updated during training and based on user feedback to produce an output classification in accordance with the training data and user feedback. The alert message machine learning model of the alert monitoring and prediction service may then output a pre-defined classification based on the result of the machine learning model. The MLP machine learning model may be trained using a training set of UGC transformed data, such as the UGC transformed data generated from monitoring service alerts in the monitoring service alert corpus.

In some embodiments, the alert monitoring and prediction service may provide mechanisms to update the alert message machine learning model based on feedback from one or more users. As described herein, in some embodiments, the alert monitoring and prediction service may utilize user feedback to update and improve the machine learning model used to classify the received monitoring service alerts. For example, in some embodiments, a user may access determined classification categories for a particular monitoring service alert through a client device (e.g., client device 102a-102n) or other user interface. A user may reclassify a monitoring service alert or otherwise provide feedback related to the classification of the monitoring service alert.

In some embodiments, the user feedback may be utilized to update one or more machine learning models in an alert message machine learning model storage (e.g., alert message machine learning model storage 510). For example, parameters, hyper-parameters, and/or defined operations of a machine learning model may be reconfigured based on the user feedback. In some embodiments, the UGC transformed alert data, for example UGC transformed alert data contained in the UGC transformed alert data storage 506 and the associated classification may be updated based on user feedback. Once the UGC transformed alert data is updated, periodic updates of one or more machine learning models stored in the alert message machine learning model storage 510 may update the machine learning models according to the user feedback.

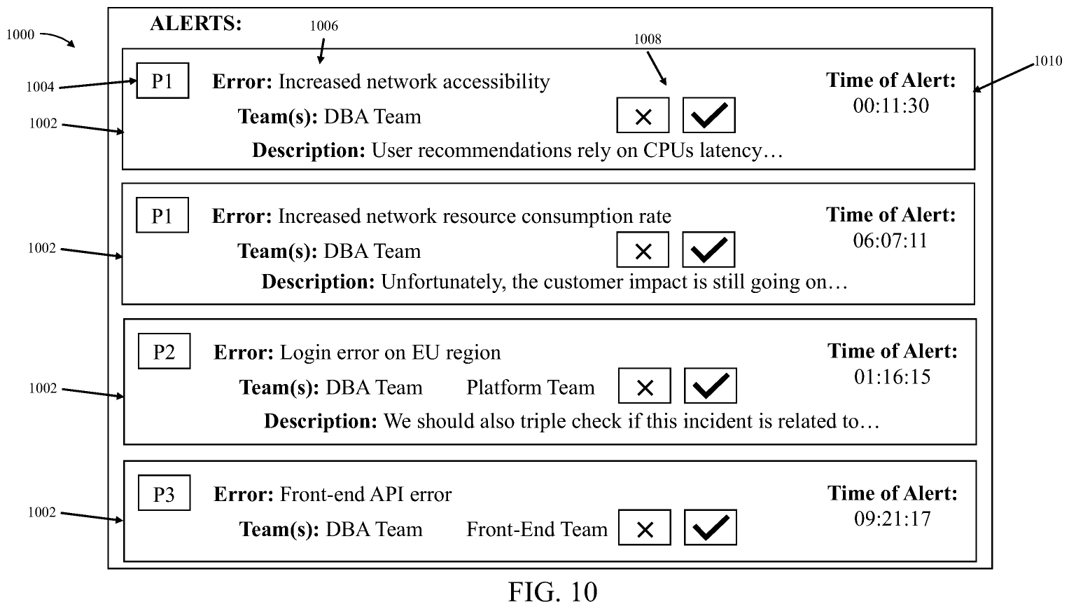

Referring now to FIG. 10, a set of example monitoring service alerts 1000 is provided. As depicted in FIG. 10, the set of example monitoring service alerts 1000 includes a plurality of monitoring service alerts 1002. Each of the monitoring service alerts may further comprise a priority 1004, text information 1006, status indicators 1008, and/or timestamps 1010.

As described herein, a monitoring service alert 1002, whether stored, for example in a monitoring service alert corpus or received during operation of the enterprise software platform 100 may comprise text information 1006. The text information 1006 may include sources of UGC, such as a title (e.g., “Error”) or a description. Text information 1006 may further identify entities (e.g., “Team(s)”). An alert monitoring and prediction service may be configured to receive and classify alerts, such as monitoring service alert 1002. To make accurate classifications and comply with regulations pertaining to UGC, the UGC contained in a monitoring service alert 1002 may first undergo one or more non-linear transformations, as described herein. A machine learning model may be generated based on the content of a plurality of monitoring service alerts 1002 by an alert message machine learning model generation module. During operation of the enterprise software platform 100, real-time monitoring service alerts may be received by an alert monitoring and prediction service and classifications and predictions may be made based on the content of the monitoring service alert 1002.

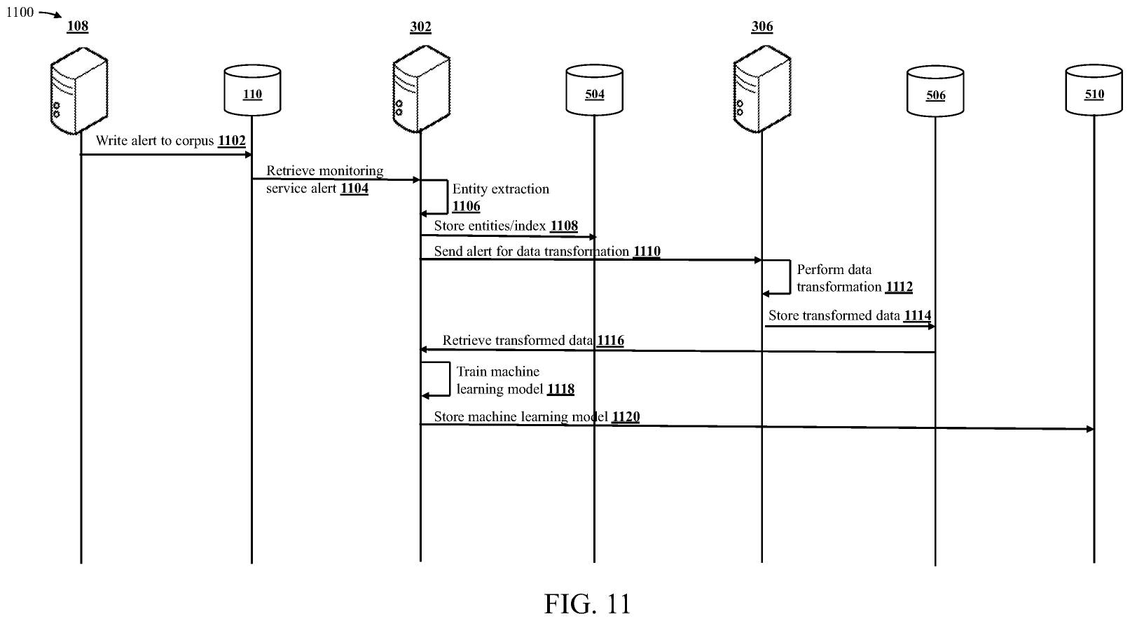

Referring now to FIG. 11, a signal diagram illustrating an example process 1100 for training an alert message machine learning model is provided. At step 1102, one or more monitoring service alerts are transmitted from an alert monitoring and prediction service (e.g., alert monitoring and prediction service 108) to a monitoring service alert corpus (e.g., monitoring service alert corpus 110). At step 1104, an alert message machine learning model generation module (e.g., alert message machine learning model generation module 302) retrieves one or more monitoring service alerts from the monitoring system alert corpus. At step 1106, the alert message machine learning model generation module identifies entities and associated indices. At step 1108, the alert message machine learning model generation module stores the entity list, map, and/or dictionary in an entity map storage (e.g., entity map storage 504).

At step 1110, the alert message machine learning model generation module sends the retrieved monitoring service alert to an alert data transformation module (e.g., alert data transformation module 306) to perform non-linear transformations. At step 1112, the alert data transformation module performs transformations to the monitoring service alert to produce UGC transformed alert data. At step 1114, the UGC transformed alert data is stored in a UGC transformed alert data storage (e.g., UGC transformed alert data storage 506).

At step 1116, the alert message machine learning model generation module retrieves a plurality of instances of transformed data from the UGC transformed alert data storage. At step 1118, the alert message machine learning model generation module trains a machine learning model based on the UGC transformed alert data contained in the UGC transformed alert data storage 506. At step 1120, the trained machine learning model is stored in an alert message machine learning model storage (e.g., an alert message machine learning model storage 510).

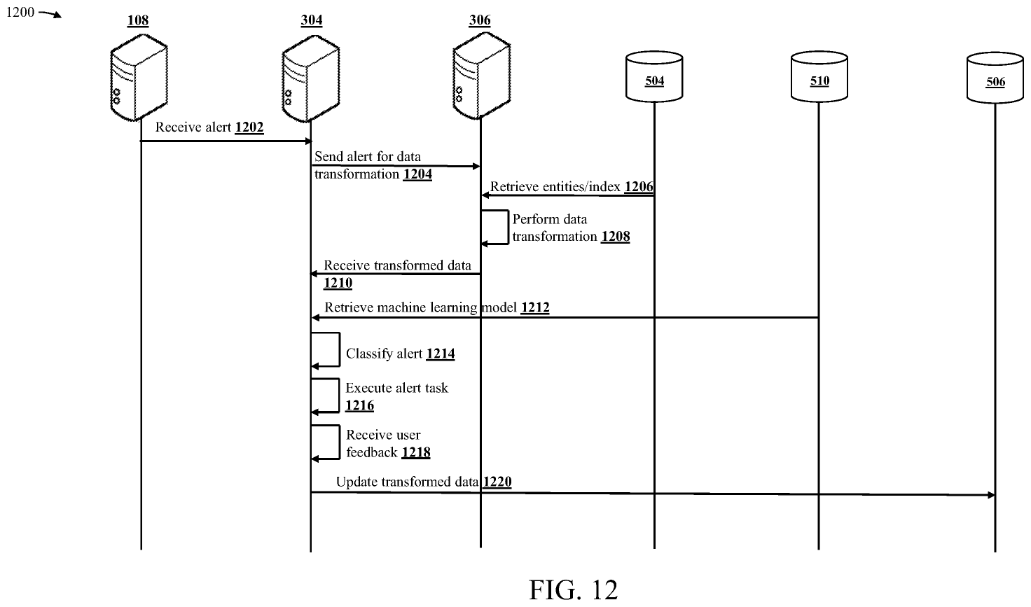

Referring now to FIG. 12, a signal diagram illustrating an example process 1200 for classifying an alert message based on a machine learning model is provided. At step 1202, a monitoring service alert is received at an alert prediction module (e.g., alert prediction module 304). At step 1204, a monitoring service alert is transmitted to an alert data transformation module (e.g., alert data transformation module 306) for data reformatting. At step 1206, the alert data transformation module retrieves the entity map from an entity map storage (e.g., entity map storage 504), such as the entity map stored in step 1108 of FIG. 11.

At step 1208, the alert data transformation module transforms the monitoring service alert based on one or more non-linear transformations as described herein. At step 1210, the alert prediction module receives the UGC transformed alert data from the alert data transformation module. At step 1212, the alert prediction module retrieves a machine learning model from an alert message machine learning model storage (e.g., alert message machine learning model storage 510) as stored by the alert message machine learning model generation module in step 1120 of FIG. 11.

At step 1214, the monitoring service alert is classified by the alert prediction module based on the content of the monitoring service alert and the trained machine learning model. At step 1216, one or more tasks are executed based on the classification of the monitoring service alert. At step 1218, user feedback is provided by a user on the enterprise software platform. At step 1220, the transformed data on a UGC transformed alert data storage (e.g., UGC transformed alert data storage 506) is updated based on the feedback of a user. In some embodiments, one or more machine learning models in the alert message machine learning model storage 510 may be updated based on the user feedback, and/or based on the updated UGC transformed alert data.

It is to be understood the implementations are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. Thus, for example, references to “an image” includes a combination of two or more images and references to “a graphic” includes different types and/or combinations of graphics.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate form the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An apparatus for categorizing a real-time monitoring service alert, the apparatus comprising at least one processor and at least one memory including program code, the at least one memory and the program code configured to, with the at least one processor, cause the apparatus to at least:
retrieve the real-time monitoring service alert,
wherein the real-time monitoring service alert comprises a text string, including user generated content (UGC) text;
programmatically parse the text string of the real-time monitoring service alert to segregate the real-time monitoring service alert into an alert message problem component and an alert auxiliary details component; and
determine, based on the alert message problem component, the alert auxiliary details component, and using an alert message machine learning model trained based on UGC transformed alert data, an alert message category of the real-time monitoring service alert.

2. The apparatus of claim 1, wherein the UGC transformed alert data comprises:
an alert message problem embedding,
wherein the alert message problem embedding is generated by applying feature extraction to the alert message problem component of the real-time monitoring service alert; and
an alert message description embedding,
wherein the alert message description embedding is generated by applying feature extraction to the alert auxiliary details component.

3. The apparatus of claim 2, wherein generating an alert message problem embedding comprises utilizing a word embedding technique on the alert message problem component.

4. The apparatus of claim 2, wherein generating an alert message description embedding comprises utilizing a sentence embedding technique on the alert auxiliary details component.

5. The apparatus of claim 1, wherein the alert message machine learning model is a machine learning classifier utilizing at least one of a support vector machine type classifier and a neural network type classifier.

6. The apparatus of claim 1, wherein the alert message machine learning model is updated based on feedback from one or more users.

7. The apparatus of claim 1, wherein segregating the real-time monitoring service alert comprises utilizing a semantic parser on the text string of the real-time monitoring service alert to segregate the alert message problem component from the alert auxiliary details component.

8. The apparatus of claim 7, wherein the semantic parser comprises at least one of a slot grammar parser and a bidirectional long-short term memory (Bi-LSTM) based conditional random field.

9. The apparatus of claim 1, wherein, segregating the real-time monitoring service alert further comprises:
identifying one or more UGC data components of the text string of the real-time monitoring service alert corresponding to the UGC text; and
replacing each of the one or more UGC data components with one or more generic data tokens based at least in part on a UGC type of the UGC data component.

10. The apparatus of claim 1, wherein generating an alert message problem embedding further comprises performing one or more data mutation processes on the alert message problem component.

11. A method for categorizing a real-time monitoring service alert, the method comprising:
retrieving the real-time monitoring service alert,
wherein the real-time monitoring service alert comprises a text string, including user generated content (UGC) text;
programmatically parsing the text string of the real-time monitoring service alert to segregate the real-time monitoring service alert into an alert message problem component and an alert auxiliary details component; and
determining, based on the alert message problem component, the alert auxiliary details component, and using an alert message machine learning model trained based on UGC transformed alert data, an alert message category of the real-time monitoring service alert.

12. The method of claim 11, wherein the UGC transformed alert data comprises:
an alert message problem embedding,
wherein the alert message problem embedding is generated by applying feature extraction to the alert message problem component of the real-time monitoring service alert; and
an alert message description embedding,
wherein the alert message description embedding is generated by applying feature extraction to the alert auxiliary details component.

13. The method of claim 12, wherein generating an alert message problem embedding comprises utilizing a word embedding technique on the alert message problem component.

14. The method of claim 12, wherein generating an alert message description embedding comprises utilizing a sentence embedding technique on the alert auxiliary details component.

15. The method of claim 11, wherein the alert message machine learning model is a machine learning classifier utilizing at least one of a support vector machine type classifier and a neural network type classifier.

16. The method of claim 11, wherein the alert message machine learning model is updated based on feedback from one or more users.

17. The method of claim 11, wherein segregating the real-time monitoring service alert comprises utilizing a semantic parser on the text string of the real-time monitoring service alert to segregate the alert message problem component from the alert auxiliary details component.

18. The method of claim 17, wherein the semantic parser comprises at least one of a slot grammar parser and a bidirectional long-short term memory (Bi-LSTM) based conditional random field.

19. The method of claim 11, wherein, segregating the real-time monitoring service alert further comprises:
identifying one or more UGC data components of the text string of the real-time monitoring service alert corresponding to the UGC text; and
replacing each of the one or more UGC data components with one or more generic data tokens based at least in part on a UGC type of the UGC data component.

20. A computer program product for categorizing a real-time monitoring service alert, the computer program product comprising at least one non-transitory computer-readable storage medium having computer-readable program code portions stored therein, the computer-readable program code portion configured to:
retrieve the real-time monitoring service alert,
wherein the real-time monitoring service alert comprises a text string, including user generated content (UGC) text;
programmatically parse the text string of the real-time monitoring service alert to segregate the real-time monitoring service alert into an alert message problem component and an alert auxiliary details component; and
determine, based on the alert message problem component, the alert auxiliary details component, and using an alert message machine learning model trained based on UGC transformed alert data, an alert message category of the real-time monitoring service alert.
